(19) United States
(12) Patent Application Publication
(10) Pub. No.: US 2024/0224251 A1
(43) Pub. Date: Jul. 4, 2024

(54) MAPPING BETWEEN CARRIERS AND DIFFERENT TYPES OF CARRIER FREQUENCIES

(71) Applicant: ZTE Corporation, Shenzhen, Guangdong (CN)

(72) Inventors: Feng XIE, Shenzhen (CN); Hanchao LIU, Shenzhen (CN); Fei WANG, Shenzhen (CN); Yan XUE, Shenzhen (CN)

(21) Appl. No.: 18/609,337

(22) Filed: Mar. 19, 2024

Related U.S. Application Data
(63) Continuation of application No. PCT/CN2021/119810, filed on Sep. 23, 2021.

(51) Int. Cl. H04W 72/0453

(52) U.S. Cl. CPC H04W 72/0453

(57) ABSTRACT

Systems, apparatus and method for wireless communication are described. One example method includes receiving, by a wireless device, a radio configuration information that includes a first carrier frequency configuration, a second carrier frequency configuration and a carrier configuration, wherein the radio configuration information includes a first correspondence between a first carrier frequency in the first carrier frequency configuration and more than one second carrier frequencies in the second carrier frequency configuration and a second correspondence between the first carrier frequencies and one or more carrier of operation; and operating the wireless device according to the radio configuration information.

### CROSS REFERENCE TO RELATED APPLICATIONS

This patent document is a continuation of and claims benefit of priority to International Patent Application No. PCT/CN2021/119810, filed on Sep. 23, 2021. The entire content of the before-mentioned patent application is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques will provide support for an increased number of users and devices.

### SUMMARY

This document relates to methods, systems, and devices for transmitting configuration information in mobile communication technology.

In one exemplary aspect, a wireless communication method is disclosed. The method includes receiving, by a wireless device, a radio configuration information for a wireless network that includes a carrier configuration and a carrier frequency configuration, wherein the radio configuration information indicates a correspondence between a carrier in the carrier configuration and more than one carrier frequencies in the carrier frequency configuration; and operating the wireless device according to the radio configuration information.

In another exemplary aspect, a wireless communication method is disclosed. The method includes transmitting, by a network device to a wireless device, a radio configuration information for a wireless network that includes a carrier configuration and a carrier frequency configuration, wherein the radio configuration information indicates a correspondence between a carrier in the carrier configuration and more than one carrier frequencies in the carrier frequency configuration.

In another exemplary aspect, another method of wireless communication is disclosed. The method includes receiving, by a wireless device, a radio configuration information that includes a first carrier configuration, a second carrier configuration and a carrier frequency configuration, wherein the radio configuration information includes a first correspondence between a first carrier in the first carrier configuration and more than one second carriers in the second carrier configuration and a second correspondence between second carriers and one or more carrier frequencies; and operating the wireless device according to the radio configuration information.

In another exemplary aspect, a wireless communication method is disclosed. The method includes transmitting, by a network device to a wireless device, a radio configuration information that includes a first carrier configuration, a second carrier configuration and a carrier frequency configuration, wherein the radio configuration information includes a first correspondence between a first carrier in the first carrier configuration and more than one second carriers in the second carrier configuration and a second correspondence between second carriers and one or more carrier frequencies.

In another exemplary aspect, a wireless communication method is disclosed. The method includes receiving, by a wireless device, a radio configuration information that includes a first carrier frequency configuration, a second carrier frequency configuration and a carrier configuration, wherein the radio configuration information includes a first correspondence between a first carrier frequency in the first carrier frequency configuration and more than one second carrier frequencies in the second carrier frequency configuration and a second correspondence between the first carrier frequencies and one or more carrier of operation; and operating the wireless device according to the radio configuration information.

In another exemplary aspect, a wireless communication method is disclosed. The method includes transmitting, by a network device to a wireless device, a radio configuration information that includes a first carrier frequency configuration, a second carrier frequency configuration and a carrier configuration, wherein the radio configuration information includes a first correspondence between a first carrier frequency in the first carrier frequency configuration and more than one second carrier frequencies in the second carrier frequency configuration and a second correspondence between the first carrier frequencies and one or more carrier of operation.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a channel bandwidth and a maximum transmission bandwidth configuration of a New Radio (NR) channel.

FIG. 2 shows an example of the relationship between a carrier, a frequency domain representation of resource grid, and bandwidth parts (BWPs).

FIG. 3 shows an example of the relationship between a carrier frequency, a bandwidth, an absolute center frequency, and a frequency band.

FIG. 4A is a schematic diagram of a carrier in some embodiments.

FIG. 4B is a schematic diagram of a carrier and relationship between a carrier, carrier frequencies, and frequency bands in some embodiments.

FIG. 4C is a schematic diagram of the correspondence between a carrier and three carrier frequencies.

FIG. 5 is a flowchart of an example method of wireless communication.

FIG. 6 shows an example of mapping from two carriers to three carrier frequencies.

FIG. 7A and FIG. 7B are two examples showing the correspondence between carriers and carrier frequencies.

FIG. 8 shows an example of a first carrier corresponding to three second carriers, each of the second carriers corresponding to one carrier frequency.

FIG. 9 is a flowchart for an example method of wireless communication.

FIG. 10 shows an example of mapping from two first carriers to three second carriers.

FIG. 11 shows an example of a carrier corresponding to one first carrier frequency, and one first carrier frequency corresponding to three second carrier frequencies.

FIG. 12 is a flowchart for an example of a wireless communication method.

FIG. 13 shows an example of mapping from two first carrier frequencies to three second carrier frequencies.

FIG. 14 shows a flowchart for an example method of wireless communication.

FIG. 15 shows an example of a wireless communication network.

FIG. 16 is a block diagram representation of a portion of an apparatus that can be used to implement methods and/or techniques of the presently disclosed technology.

FIGS. 17A-17F show flowcharts for example methods of wireless communication.

### DETAILED DESCRIPTION

Section headings are used in the present document only to improve readability and do not limit scope of the disclosed embodiments and techniques in each section to only that section.

The wireless spectrum is mainly used for communication coverage of mobile networks and is a non-renewable resource. Different countries have different radio spectrum policies, and radio spectrum planning has caused conflicts between spectrum supply and demand. Many countries around the world adopt the market-oriented auction method of spectrum, and operators purchase some frequency bands at a higher cost. In addition, due to the slow generational change, operators have to operate networks of multiple standards at the same time, facing the coexistence of 2G/3G/4G/5G for a long period of time. Most of the communication networks of different standards and different generations each occupy an independent frequency spectrum, and the occupied bandwidth is also different. With the withdrawal or phasing out of 2G and 3G networks, these spare spectrum resources also need to be re-farmed. These factors have led to the severe fragmentation of the current global spectrum resources, especially at low frequencies, it has been difficult to find continuous large-bandwidth spectrum resources. With the acceleration of 5G commercialization and the emergence of new 6G services, new scenarios, and new applications, it is necessary to support greater bandwidth and higher throughput in the future. The efficient use of fragmented spectrum will greatly alleviate the shortage of global spectrum resources.

In the prior art, multiple fragmented spectrum resources cannot be used efficiently, resulting in an inefficient use of spectrum.

A carrier is used as a carrier for the communication coverage of the mobile network. For the terminal equipment (called user equipment UE), in the uplink transmission direction or the downlink transmission direction, the channel bandwidth of the UE supports one radio frequency carrier. From the perspective of the base station, the channel bandwidths of different UEs are all included in the same spectrum range, and the spectrum range is used for data transmission and reception between the base station and the UE. The channel bandwidth of the base station includes multiple carriers used for transmission with the same UE, and also includes multiple carriers used for transmission with different UEs. The multiple carriers used for transmission with the same UE correspond to a carrier aggregation.

From the perspective of the UE, the UE is configured with one or more bandwidth parts BWPs/carriers, and each BWP/carrier has a UE channel bandwidth. The UE only needs to pay attention to its own channel bandwidth and does not need to know the channel bandwidth of the base station, nor does it need to know how the base station allocates bandwidth to other UEs.

For each carrier used for transmission between the UE and the base station, the distribution of the channel bandwidth of the UE on the carrier may be flexible, but the channel bandwidth of the UE can only be distributed within the range of the channel bandwidth of the base station.

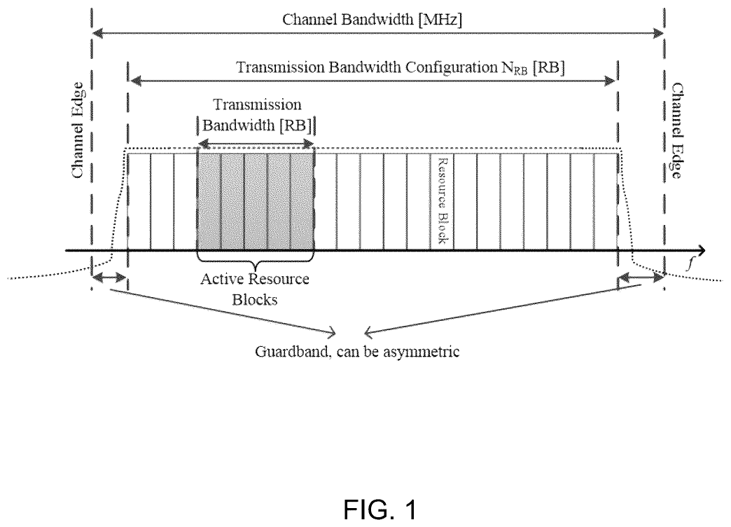

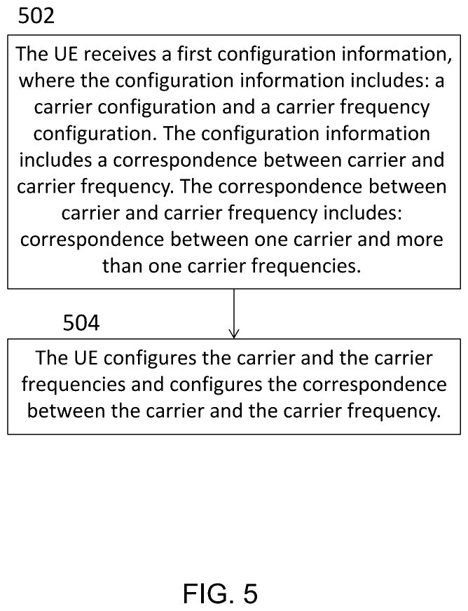

The relationship between the channel bandwidth, a guard band, and a maximum transmission bandwidth configuration is shown in FIG. 1 which shows a definition of the channel bandwidth and maximum transmission bandwidth configuration of an NR channel, derived from FIG. 5.3.1-1 in 3GPP 38101-1.

According to the description of Resource grid in section 4.4.2 in the 3GPP standard specification 38211: for each carrier and each sub-carrier spacing, in the uplink or downlink transmission direction, a resource grid is defined respectively, and the resource grid includes a series of continuous subcarriers and a series of continuous time-domain OFDM symbols. The carrierBandwidth in the radio resource control RRC information element IE SCS-SpecificCarrier configures the bandwidth of the resource grid, and the offsetToCarrier in the Radio resource control information element (RRC IE)SCS-SpecificCarrier configures the frequency domain start position of the resource grid. In addition, the txDirectCurrentLocation in the RRC IE UplinkTxDirectCurrentBWP and the txDirectCurrentLocation in the SCS-SpecificCarrier respectively configure the frequency domain locations of the upstream and downstream DC subcarriers of the resource grid of the resource grid.

The RRC IE SCS-SpecificCarrier provides configuration parameters related to the carrier bandwidth at the subcarrier spacing level, and the configuration parameters determine the frequency domain position of the carrier bandwidth (refer to PointA) and the width of the frequency domain range of the carrier bandwidth. For the subcarrier spacing corresponding to each BWP, an RRC IE SCS-SpecificCarrier is configured.

For example, in section 4.4.5 of the 3GPP standard specification 38211: a BWP is a subset of continuous common resource blocks (CRB) corresponding to a specific sub-carrier spacing on a given carrier. The frequency domain start of BWP and the number of RBs included need to meet:

$${N}_{grid , x}^{s t art , μ} \leq {N}_{BWP , i}^{s t a rt , μ} < {N}_{grid , x}^{s t art , μ} + {N}_{grid , x}^{s ize , μ} ,$$

$$and$$

$${N}_{grid , x}^{s t art , μ} < {N}_{BWP , i}^{start , μ} + {N}_{BWP , i}^{s ize , μ} \leq {N}_{grid , x}^{s t art , μ} + {N}_{grid , x}^{size , μ}$$

where N_{grid, x}^{start, μ} represents the start of the frequency domain of the resource grid, N_{grid, x}^{start, μ} represents the width of the frequency domain of the resource grid, N_{BWP, i}^{start, μ} represents the start of the frequency domain of the i-th BWP on the carrier, N_{BWP, i}^{start, μ} represents the width of the frequency domain of the i-th BWP on the carrier, μ represents The subcarrier spacing coefficient, x is used to indicate the identifier of the uplink resource grid or the downlink resource grid.

For a downlink carrier, the UE may configure a maximum of 4 downlink BWPs, and activates a maximum of one BWP in a given time. The UE may not receive a physical downlink shared channel PDSCH, a physical downlink control channel PDCCH, or a channel state information reference signal CSI-RS (except radio resource management RRM) in the frequency domain outside the BWP (bandwidth part).

For an uplink carrier, the UE may configure up to 4 uplink BWPs, and activate up to one BWP at a time. When the UE is configured with supplementary uplink (SUL), the UE can additionally configure up to 4 uplink BWPs on the SUL carrier, and activate up to one BWP in a given time. The UE will not transmit a physical uplink shared channel PUSCH or a physical uplink control channel PUCCH in the frequency domain outside the activated BWP. For an activated carrier, the UE will not send SRS in the frequency domain outside the activated BWP.

A cell of wireless communication may use carrier resources to send and/or receive data packets. The carrier resources include: the bandwidth of the carrier, the frequency of the carrier, and the frequency band of the carrier. The bandwidth of the carrier is a factor that determines the throughput of the cell. When the bandwidth of the carrier is small, larger data packets typically cannot be transmitted on these carriers, which limits the cell traffic. In some scenarios, there are a large number of carriers of the small bandwidth, which affects the data transmission efficiency. Carrier aggregation (CA) uses a larger frequency domain bandwidth formed by the aggregation of multiple carriers, which improves the data transmission efficiency. However, carrier aggregation also has some shortcomings, because carrier aggregation requires the configuration of multiple cells, each cell corresponds to a carrier, and each cell needs to transmit its own signaling. The signaling includes high-layer signaling, such as RRC reconfiguration signaling; L1/L2 signaling, such as MACCE (media access control layer control element) or DCI (downlink control indicator).

The transmission of such signaling will occupy part of the bandwidth resources, thereby reducing the spectrum utilization. On the other hand, due to the configuration of multiple cells, the process of releasing/adding secondary cells during cell handover will increase the interruption time of data transmission and reduce the throughput of the cell.

In various embodiments disclosed herein, the following parameters and concepts may be used.

Carrier: may represent a collection of sub-carriers based on one sub-carrier spacing. It can also be called a virtual carrier or a baseband carrier.

Further, the carrier is associated with one or more BWPs. The subcarrier spacing of a carrier is equal to the subcarrier spacing of each associated BWP. The starting RB and the number of RBs of the carrier and the starting RB and the number of RBs of the associated BWP meet respectively. N_{VC}^{start}≤N_{BWP, i}^{start}≤N_{VC}^{start}+N_{VC}^{size} N_{VC}^{start}≤N_{BWP, i}^{start}+N_{BWP, i}^{size}, ≤N_{VC}^{start}+N_{VC}^{size} in which N_{VC}^{start} is the starting position of the RB of the carrier; N_{VC}^{size} is the number of RBs of the carrier; N_{BWP, i}^{start} is the starting position of the RB of the i-th BWP associated with the carrier; N_{BWP, i}^{size} is the number of RBs of the i-th BWP associated with the carrier.

The carrier may be associated with one resource grid. Subcarrier spacing of a carrier is equal to sub-carrier spacing of the associated resource grid. The start RB and RB number of the carrier and the start RB and RB number of the associated resource grid meet respectively: N_{VC}^{start}≤N_{rescourcegrid}^{start}≤N_{VC}^{start}+N_{VC}^{size}, N_{VC}^{start}≤N_{resource,grid}^{start}+N_{resourcegird}^{size}≤N_{VC}^{start}+N_{VC}^{size}, in which N_{VC}^{start} is the starting position of the RB of the carrier; N_{VC}^{size} is the number of RBs of the carrier; N_{resourcegrid}^{start} is the starting position of the RB of the resource grid associated with the carrier; N_{resourcegrid}^{size} is the number of RBs of the resource grid associated with the carrier. Carriers include the carrier used for uplink transmission, the carrier used for downlink transmission, the carrier used for Sidelink transmission, the carrier used for both uplink transmission and downlink transmission.

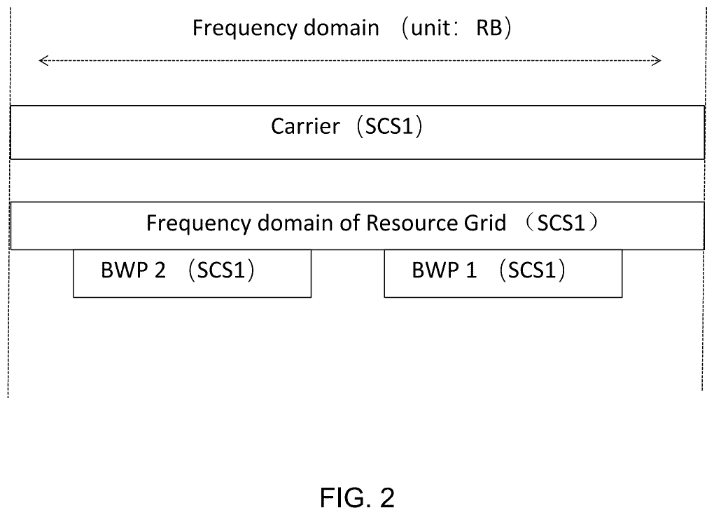

FIG. 2 shows an example of the relationship between a carrier, a frequency domain representation of resource grid, and BWP. As depicted from bottom to top, a resource grid may comprise two bandwidth parts having same subcarrier spacing (RG1 with BWP1 and SCS1, and with BWP2 and SCS1), which are included in a carrier that occupies resources in the frequency domain.

Carrier frequency: may correspond to an absolute frequency range (for example, 2450 MHz to 2550 Mhz), or an absolute frequency range in a frequency band. The absolute frequency range can be expressed by the absolute center frequency point (in ARFCN) and bandwidth. The carrier frequency can also be called a physical carrier or a Radio frequency carrier.

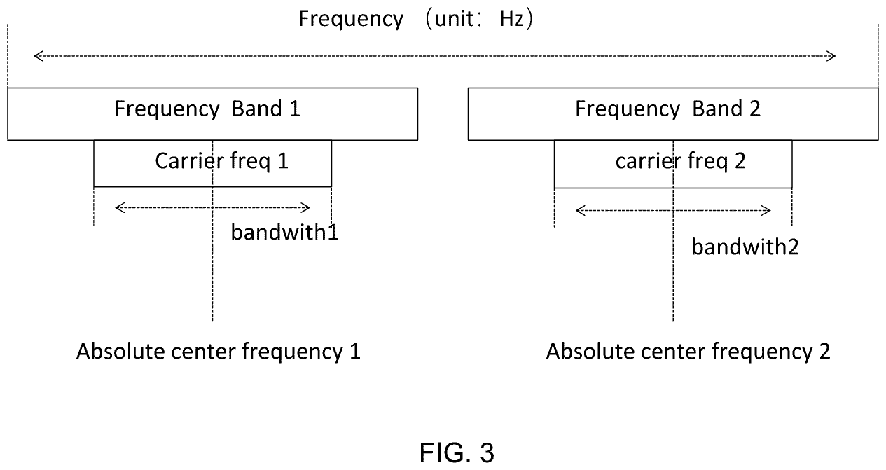

FIG. 3 shows an example of the relationship between carrier frequency, bandwidth, absolute center frequency, and frequency band.

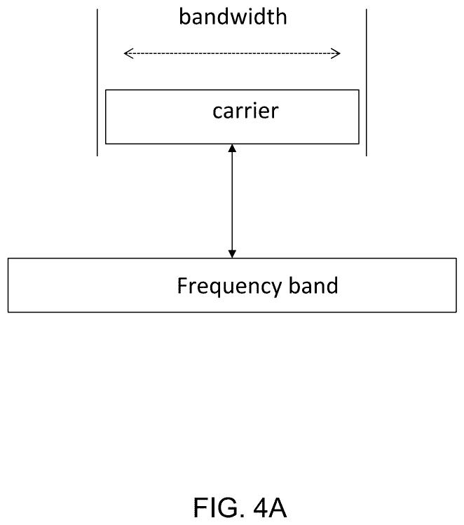

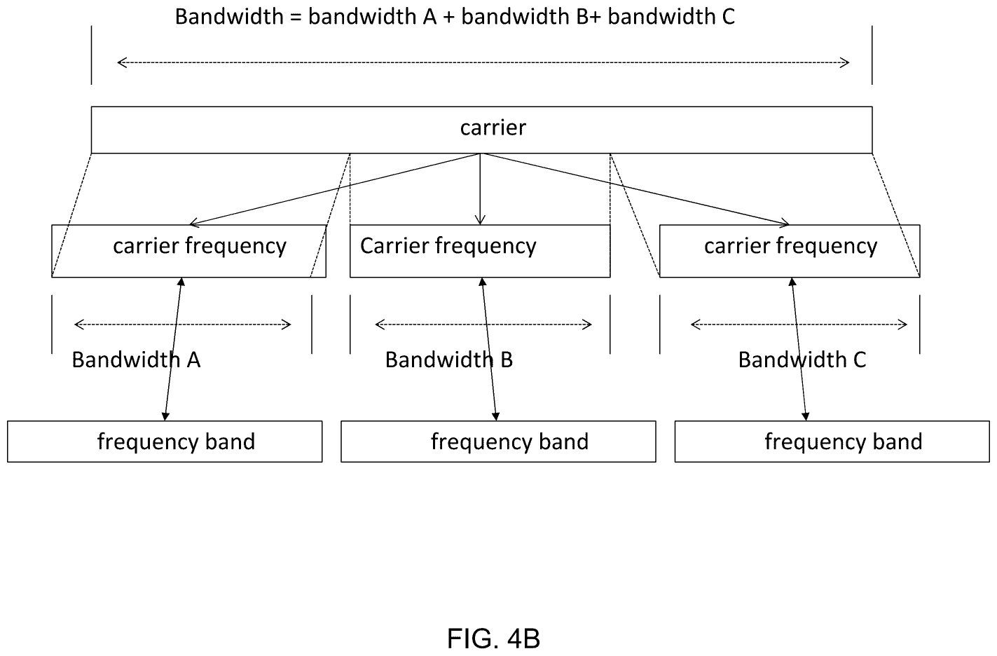

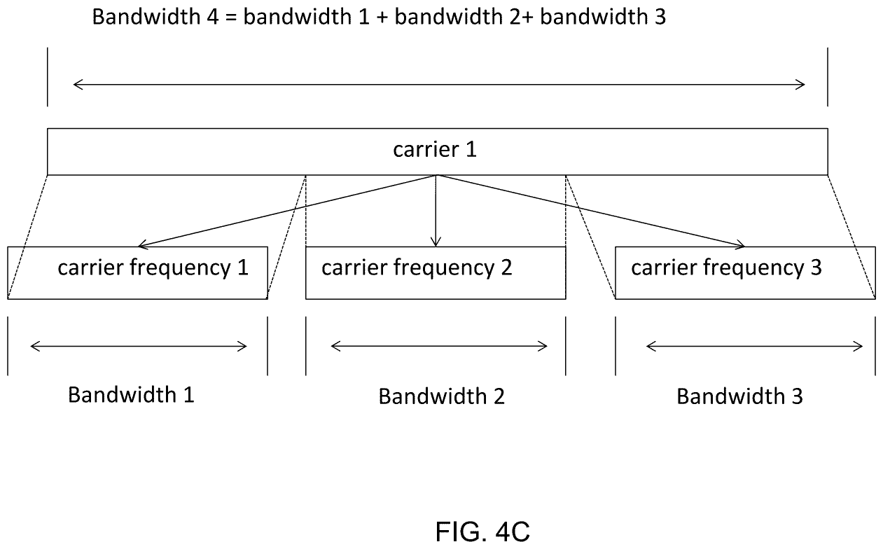

The carrier may be associated with both baseband processing and radio frequency processing. baseband processing corresponds to digital signal processing or processing related to resource mapping; radio frequency processing corresponds to analog signal processing, or processing related to absolute frequency. The digital signal processing/baseband processing/processing related to resource mapping includes channel coding, modulation and demodulation, channel measurement, etc., corresponding to the content in the 3GPP standard specification RANi. The analog signal processing/radio frequency processing/processing related to the absolute frequency includes processing related to the absolute frequency and frequency band, corresponding to the content in the 3GPP standard specification RAN4. One carrier corresponds to one sub-carrier spacing, one frequency point and one bandwidth. The frequency point of the carrier indicates the frequency domain position by the offset from the frequency domain reference point PointA. The bandwidth of the carrier is limited by the bandwidth of the corresponding frequency band. For a fragmented spectrum, spectrum resources are limited, and the bandwidth of the corresponding carrier will be correspondingly limited, which will be too small to meet the requirement of large throughput. The utilization efficiency of the spectrum resources of multiple such carriers will be very low. FIG. 4A is a schematic diagram of a carrier in the prior art.

In some embodiments, the carrier frequency corresponds to an absolute center frequency point and a radio frequency-related bandwidth, and corresponds to an absolute frequency range, for example, 2450 MHz to 2550 Mhz. The Carrier frequency may be related to analog signal processing/radio frequency processing/processing related to absolute frequency. The carrier disclosed herein, a collection of subcarriers, corresponds to one subcarrier spacing. Carrier may be related to digital signal processing/baseband processing/processing related to resource mapping. In this patent document, the correspondence between carrier and carrier frequency may be that one carrier corresponds to more than one carrier frequencies. The bandwidth of a carrier may be equal to the sum of the bandwidths of more than one carrier frequencies, or the sum of the bandwidths of multiple carriers is equal to the sum of the bandwidths of multiple carrier frequencies. Such a carrier can correspond to more than one absolute frequency ranges, and can correspond to the sum of more than one RF-related bandwidths. For a fragmented spectrum, the bandwidth of a carrier is equal to the sum of the bandwidth of more than one spectrum resources, thereby a carrier corresponds to a larger bandwidth, which improves utilization efficiency of spectrum resources. FIG. 4B is a schematic diagram of a carrier in some embodiments.

### Embodiment 1

In some embodiments, one carrier (baseband carrier) corresponds more than one carrier frequencies (RF carrier), and the bandwidth of the carrier is equal to the sum of the bandwidth of these more than one carrier frequencies.

FIG. 4C is a schematic diagram of the correspondence between a carrier and three carrier frequencies. Carrier 1 corresponds to carrier frequency 1, carrier frequency 2, and carrier frequency 3; bandwidth 4 (bandwidth of carrier 1) is equal to the sum of bandwidth 1 (bandwidth of carrier frequency 1), The sum of bandwidth 2 (the bandwidth of carrier frequency 2), and bandwidth 3 (the bandwidth of carrier frequency 3).

The carrier includes one collection of subcarriers with a subcarrier spacing, and the carrier corresponds to a reference subcarrier spacing. Each collection of subcarriers corresponds to a subcarrier spacing configuration, which is used to indicate the subcarrier spacing of the collection of subcarriers. The subcarrier spacing configuration can be 0, 1, 2, . . . , which respectively represents 2^{μ} multiples of the reference subcarrier spacing. Each subcarrier of the carrier corresponds to one RE (resource element), and 12 REs correspond to an RB (resource block). Like this, the carrier includes one or more RE collections or one or more RB collections. The carrier may be associated with a resource grid. The subcarriers of the resource grid are mapped to the subcarriers of the carrier. The information on the RE of the resource grid is mapped to the RE of the carrier, and the information on the RB of the resource grid is mapped to the RB of the carrier. The carrier may be associated with one or more BWPs. The subcarriers of the BWP are mapped to the subcarriers of the carrier. The information on the RE or RB of the BWP is mapped to the RE or RB of the carrier.

In some embodiments, the carrier is associated with baseband processing, such as resource mapping. Radio resources associated with baseband processing can be mapped to the REs or RBs of carrier. For example, physical channels and/or physical reference signals are mapped to REs or RBs of the carrier; or physical channels and/or physical reference signals are mapped to REs or RBs of the resource grid, and information on REs or RBs of the resource grid is remapped to the RE or RB of the carrier; or the physical channel and/or physical reference signals are mapped to the RE or RB of the BWP, and the information on the RE or RB of the BWP is then mapped to the RE or RB of the carrier; or the physical channel and/or the physical reference signals are mapped to the RE or RB of the BWP, the information on the RE or RB of the BWP is then mapped to the RE or RB of the resource grid, and the information on the RE or RB of the resource grid is then mapped to the RE or RB of the carrier.

In some embodiments, the carrier frequency corresponds to an absolute frequency domain range, such as 2450 MHz to 2550 Mhz. The carrier frequency corresponds to an absolute center frequency and a bandwidth, for example, the absolute center frequency is 2.6 GHz and the bandwidth is 100 MHz.

In this patent document, one carrier may correspond to more than one carrier frequencies, the carrier corresponds to more than one absolute frequency ranges, corresponds to more than one absolute center frequencies, and corresponds to more than one frequency bands. In some cases, the carrier is mapped to the more than one carrier frequencies. A part of collection of subcarriers of the carrier are mapped to the frequency range of one of the carrier frequencies, another part collection of subcarriers of the carrier are mapped to the frequency range of another one of the carrier frequencies. Each subcarrier of the carrier corresponds to an absolute frequency. The bandwidth of the carrier is equal to the sum of the bandwidth of the corresponding more than one carrier frequencies.

For example, in some embodiments, one carrier corresponds to two carrier frequencies. The two carrier frequencies may be 2450 MHz to 2480 Mhz and 2500 MHz to 2530 Mhz respectively. The bandwidth of this carrier is equal to the sum of the bandwidth of these two carrier frequencies, 30 MHz+30 MHz=60 MHz. The carrier corresponds to two frequency ranges: 2450 MHz to 2480 Mhz and 2500 MHz to 2530 Mhz.

At present, due to auction-style spectrum resource allocation methods and re-cultivation of spectrum resources occupied by 2G/3G networks, there are a large number of fragmented spectrum resources at low frequencies, especially for FDD (frequency division duplexing) spectrum. The bandwidth of most spectrum resources is not larger over 30 MHz, the fragmentation of the spectrum reduces the efficiency of the use of spectrum resources. According to the method of this scheme, a carrier can work on more than one fragmented spectrums at the same time. For example, one carrier may correspond to more than one carrier frequencies with a small bandwidth, and the bandwidth of the carrier is equal to the sum of the bandwidths of these carrier frequencies. In such cases, a carrier with a larger bandwidth is formed, which improves the use efficiency of spectrum resources.

For example, one carrier may correspond to 10 carrier frequencies, each of them with a bandwidth of 10 MHz, and the bandwidth of the carrier is equal to the sum of the bandwidths of these 10 carrier frequencies, which is equal to 100 MHz.

For transmitting communication nodes such as base stations or terminals, the mapping from carrier to carrier frequency can be implemented in a module responsible for radio frequency processing, including but not limited to: filtering, digital signal and analog signal conversion, power amplification, and frequency shifting. In this module, signal on the carrier from the module responsible for baseband processing are mapped to corresponding more than one carrier frequencies, and each carrier frequency corresponds to an absolute center frequency, a bandwidth, and a frequency band.

FIG. 5 is a flowchart of the UE processing of the method of the present invention in this embodiment, and the steps include:

Step 1 (502): The UE receives a first configuration information, where the configuration information includes: a carrier configuration and a carrier frequency configuration.

The configuration information may include: a correspondence between carrier and carrier frequency, and the correspondence may be in the carrier configuration information, or in the carrier frequency configuration information, or separately indicated.

The correspondence between carrier and carrier frequency may include: correspondence between one carrier and more than one carrier frequencies, or the correspondence between multiple carriers and multiple carrier frequencies.

For the case where one carrier corresponds to more than one carrier frequencies, the bandwidth of one carrier is equal to the sum of the bandwidths of the carrier frequencies: BW_{C}=ΣBW_{F, j}, where BW_{C} represents the bandwidth of the carrier; BW_{F, j} represents the bandwidth of the j-th carrier frequency.

For the case where M carriers corresponding to N carrier frequencies with 1≤M≤N, the sum of the bandwidths of M carriers is equal to the sum of the bandwidths of N carrier frequencies: Σ_{M} BW_{C,i}=Σ_{N} BW_{F,j} where BW_{C,i} represents the bandwidth of the i-th carrier and BW_{F,j} represents the bandwidth of the j-th carrier frequency.

In the prior art, the carrier corresponds to one or more frequency band information and a frequency domain reference point PointA. The carrier configuration includes a frequency offset relative to the frequency domain reference point PointA, a bandwidth, and a subcarrier spacing. The frequency domain information configuration includes frequency band list, frequency domain reference point PointA, and carrier configuration list. In this way, the carrier, the frequency band, and the frequency domain reference point PointA have a corresponding relationship.

For example: a Resource control information unit (RRC IE) FrequencyInfoDL may be as follows:

FrequencyInfoDL :: = SEQUENCE {
frequencyBandList
absoluteFrequencyPointA
scs-SpecificCarrierList
...
},

where frequencyBandList represents the frequency band corresponding to the carrier; absoluteFrequencyPointA represents the frequency domain position of the frequency domain reference point PointA, which is represented by ARFCN here; scs-SpecificCarrierList represents the list of carrier configuration. ARFCN is an absolute radio frequency channel number.

Resource Control Information Unit ( RRC IE ) SCS-SpecificCarrier:
SCS-SpecificCarrier :: = SEQUENCE {
offsetToCarrier
subcarrierSpacing
carrierBandwidth
...
},

where SCS-SpecificCarrier represents the configuration of the carrier; offsetToCarrier represents the frequency domain offset between the carrier and the frequency domain reference point PointA, thereby determining the frequency domain position of the carrier; subcarrierSpacing represents the subcarrier spacing of the carrier; carrierBandwidth indicates the bandwidth of the carrier.

In some embodiments, the configuration of the carrier includes: carrier index, sub-carrier spacing, and bandwidth. The configuration of the carrier frequency includes: the carrier frequency index, the absolute frequency point in ARFCN, the bandwidth, and the frequency band.

The correspondence between carrier and carrier frequency includes one of the following methods: the carrier frequency index is included in the carrier configuration; the configuration of the carrier includes the configuration of the carrier frequency; the carrier frequency configuration includes the index of the carrier; the carrier configuration includes an array corresponding to carrier frequency information, and each element in the array corresponds to one carrier frequency information, and the carrier frequency information includes: absolute frequency point, bandwidth, and frequency band list; or a configuration includes a carrier index and carrier frequency indexes.

The configuration of the carrier, the configuration of the carrier frequency, and the configuration of the corresponding relationship between the carrier and the carrier frequency can be represented by radio resource control information element (RRC IE) in this embodiment, including at least one of the following methods.

### Method 1.1:

The first radio resource control information element (RRC IE) represents carrier configuration information, including: Carrier index, Subcarrier spacing, Carrier bandwidth, and a list of indexes of corresponding carrier frequencies; the second radio resource control information element (RRC IE) represents carrier frequency configuration information, including: Carrier frequency index, Absolute frequency, Carrier frequency bandwidth; and Corresponding frequency band list.

Furthermore,

Carrier configuration:: = SEQUENCE {
carrier Index INTEGER (1..maximum number of carrier Index);
subcarrier Spacing ENUMERATED {kHz15, kHz30, kHz60, kHz120, kHz240, spare3, spare2,
spare1}
carrier bandwidth INTEGER (1..maximum number of RB)
corresponding carrier frequency index list SEQUENCE (SIZE (1.. maximum number of carrier
frequency index)) OF carrier frequency index
}
Carrier frequency configurations:: = SEQUENCE {
carrier frequency index INTEGER (1..maximum number of carrier frequency index)
absolute frequency ARFCN-Value
carrier frequency bandwidth INTEGER (0..maxValue), unit: Hz
corresponding frequency band list SEQUENCE (SIZE (1..maximum number of
FreqBandIndicator)) OF FreqBandIndicator
},

where the carrier index indicates the index of the carrier; the sub-carrier spacing indicates the sub-carrier spacing of the carrier; the carrier bandwidth indicates the bandwidth of the carrier; the list of the corresponding carrier frequency index indicates the indexes of the carrier frequency corresponding to the carrier; the carrier frequency index indicates index of the carrier frequency; absolute frequency point represents the absolute frequency point of the carrier frequency; carrier frequency bandwidth represents the bandwidth of the carrier frequency; the corresponding frequency band list represents the frequency bands corresponding to the carrier frequency. ARFCN is absolute radio frequency channel number. FreqBandIndicator represents frequency band indicator, which is used to indicate frequency band. maxValue is the maximum value.

### Method 1.2:

The first radio resource control information element (RRC IE) represents frequency domain information configuration, including: carrier frequency information list, each element of which is composed of absolute frequency point, bandwidth, and frequency band list; the absolute frequency domain position of the reference point (PointA); and a carrier configuration list. The second radio resource control information element (RRC IE) represents carrier configuration, including: subcarrier spacing; frequency domain offset relative to the reference point (PointA); carrier bandwidth; and an array, each value in the array corresponds to the position of the element in the carrier frequency information list. For example, the array {1,3,5} represents the first, third and fifth elements in the carrier frequency information list.

Furthermore,

Frequency domain information configuration:: = SEQUENCE {
carrier frequency information list SEQUENCE (SIZE (1... maximum number of Carrier
frequency information)) OF Carrier frequency information
absolute frequency domain position of the reference point (PointA) ARFCN-Value
carrier configuration list SEQUENCE (SIZE (1: the maximum number of Carrier
configuration)) OF Carrier configuration
}
Carrier configuration:: = SEQUENCE {
subcarrier spacing ENUMERATED {kHz15, kHz30, kHz60, kHz120, kHz240, spare3, spare2,
spare 1}
frequency domain offset relative to the reference point (PointA) INTEGER (0...maxValue)
unit: Hz
carrier bandwidth INTEGER (1..maximum number of RB)
corresponding carrier frequency information list SEQUENCE (SIZE (1.. the maximum number
of carrier frequency information)) OF INTEGER (1...maximum number of carrier frequency
information)
}
Carrier frequency information:: = SEQUENCE {
absolute frequency ARFCN-Value
carrier frequency bandwidth INTEGER (0..maxValue), unit: Hz
frequency band list SEQUENCE (SIZE (1: maximum number of FreqBandIndicator)) OF
FreqBandIndicator
},

where the carrier frequency information includes the absolute frequency of the carrier frequency, the bandwidth of the carrier frequency, and the frequency bands corresponding to the carrier frequency. The absolute frequency domain position of the reference point (PointA) represents the absolute frequency domain position of the reference point (PointA), which is represented by ARFCN. The subcarrier spacing represents the subcarrier spacing of the carrier. The frequency domain offset relative to the reference point (PointA) represents the frequency offset of the carrier from the reference point (PointA). The carrier bandwidth represents the bandwidth of the carrier. The Corresponding carrier frequency information list represents the collection of carrier frequency information corresponding to the carrier, expressed in the form of an array (SEQUENCE). Each value corresponds to the position of the element in the carrier frequency information list. The value 1 represents the first element in the carrier frequency information list, the value 2 represents the second element in the carrier frequency information list, and so on. The Corresponding carrier frequency information list field can be configured to contain more than one elements, each corresponding to a Carrier frequency information IE, which represents the carrier corresponds to more than one carrier frequencies. ARFCN is the absolute radio frequency channel number. FreqBandIndicator represents frequency band indicator, which is used to indicate frequency band. maxValue is maximum value.

### Method 1.3:

The first radio resource control information element (RRC IE) represents carrier configuration information, including: carrier index, subcarrier spacing, and bandwidth. The second radio resource control information element (RRC IE) represents carrier frequency configuration information, including: carrier frequency index, absolute frequency, bandwidth, a list of frequency bands to which it belongs, and a list of corresponding carrier indexes.

Furthermore,

Carrier configuration:: = SEQUENCE {
carrier index INTEGER (1..maximum number of carrier index);
subcarrier spacing ENUMERATED {kHz15, kHz30, kHz60, kHz120, kHz240, spare3, spare2,
spare1}
bandwidth INTEGER (1..maximum number of RB)
}
Carrier frequency configuration:: = SEQUENCE {
carrier frequency index INTEGER (1..maximum number of carrier frequency index)
absolute frequency ARFCN-Value
carrier frequency bandwidth INTEGER(0..maxValue), unit: Hz
frequency band list SEQUENCE (SIZE (1: maximum number of FreqBandIndicator)) OF
FreqBandIndicator
corresponding carrier index list SEQUENCE (SIZE (1: maximum number of elements in the
list)) OF carrier index
},

where the carrier index indicates the index of the carrier; the subcarrier spacing indicates the subcarrier spacing of the carrier; the carrier bandwidth indicates the bandwidth of the carrier; Corresponding carrier index list indicates the indexes of the carrier corresponding to the carrier frequency; the carrier frequency index indicates the index of the carrier frequency; The absolute frequency represents the absolute frequency point of the carrier frequency; the carrier frequency bandwidth represents the bandwidth of the carrier frequency; the frequency band list represents the frequency bands corresponding to the carrier frequency. ARFCN is absolute radio frequency channel number. FreqBandIndicator represents frequency band indicator, which is used to indicate frequency band. maxValue is maximum value.

### Method 1.4:

The first radio resource control information element (RRC IE) represents carrier configuration information, including: Carrier index, Subcarrier spacing, and bandwidth. The second radio resource control information element (RRC IE) represents carrier frequency configuration information, including: carrier frequency index, absolute frequency, bandwidth, and list of corresponding frequency bands. The third radio resource control information element (RRC IE) indicates the configuration information of correspondence between carrier and carrier frequencies, including a list, each element in the list is mainly composed of two parts: a carrier index, and a list of carrier frequency indexes.

Carrier configuration:: = SEQUENCE {
carrier index INTEGER (1..maximum number of carrier index);
subcarrier spacing ENUMERATED {kHz15, kHz30, kHz60, kHz120, kHz240, spare3, spare2,
spare1}
bandwidth INTEGER (1..maximum number of RB)
}
Carrier frequency configuration:: = SEQUENCE {
carrier frequency index INTEGER (1..maximum number of carrier frequency index)
absolute frequency ARFCN-Value
carrier frequency bandwidth INTEGER(0..maxValue), unit: Hz
corresponding frequency band list SEQUENCE (SIZE (1: maximum number of
FreqBandIndicator)) OF FreqBandIndicator
}
Correspondence between carrier and carrier frequency list:: = SEQUENCE (SIZE (1..maximum
number of Correspondence between the carrier and the carrier frequency)) OF
Correspondence between carrier and carrier frequency;
Correspondence between carrier and carrier frequency:: = SEQUENCE{
carrier index INTEGER (1..maximum number of carrier index)
carrier frequency index list SEQUENCE (SIZE (1..maximum number of carrier frequency
index)) OF carrier frequency index
},

where the carrier index indicates the index of the carrier; the subcarrier spacing indicates the subcarrier spacing of the carrier; the carrier bandwidth indicates the bandwidth of the carrier; the carrier frequency index indicates the index of the carrier frequency; the absolute frequency represents the absolute frequency point of the carrier frequency; the carrier frequency bandwidth represents the bandwidth of the carrier frequency; the correspondence between carrier and carrier frequencies indicates that one carrier (indicated by the carrier index in the correspondence between carrier and carrier frequency field) corresponds to carrier frequencies (Indicated by the carrier frequency index list in the correspondence between carrier and carrier frequency field). The correspondence between carrier and carrier frequency list can configure the correspondence between a carrier and more than one carrier frequencies, which represents one carrier corresponds to more than one carrier frequencies. ARFCN is absolute radio frequency channel number. FreqBandIndicator represents frequency band indicator, which is used to indicate frequency band. maxValue is maximum value.

The correspondence between the carrier and the carrier frequency is configured through an RRC message, which includes RRCsetup, RRCReconfiguration, ReconfigurationWithSync, or system messages. The system message includes: SIB1.

Further, the system message received by the UE in the IDLE state or the INACTIVE state includes the correspondence, and the RRCsetup and/or RRCReconfiguration received by the UE in the connected state includes the correspondence.

During the cell handover process, the ReconfigurationWithSync received by the UE includes the correspondence.

The correspondence between the carrier and the carrier frequency may be modified through high-layer signaling. The high-layer signaling includes: RRCReconfiguration.

The configuration of the correspondence between carrier and carrier frequency includes: UE-level configuration: configuring the same corresponding for all cells configured for UE; or, Cell Group level configuration: for the Cell Groups configured for UE, one corresponding is configured for each Cell Group, and all cells of the Cell Group use the same configured corresponding, and the corresponding is independently configured between Cell Groups; or, Cell-level configuration: for the cells configured for UE, one corresponding is configured for each cell, and the corresponding can be independently configured between the cells.

Step 2 (504): UE configures the carrier and the carrier frequencies and configures the correspondence between carrier and carrier frequency. The correspondence between carrier and carrier frequency includes: one carrier corresponds to more than one carrier frequencies, or M carriers correspond to N carrier frequencies, where 1≤M≤N. For the case where one carrier corresponds to more than one carrier frequencies, the bandwidth of one carrier is equal to the sum of the bandwidths of more than one carrier frequencies: BW_{C}=ΣBW_{F,j}, where BW_{C} represents the bandwidth of the carrier and BW_{F,j} represents the bandwidth of the j-th carrier frequency. For the case where M carriers correspond to N carrier frequencies, the sum of the bandwidths of the M carriers is equal to the sum of the bandwidths of the N carrier frequencies: Σ_{M} BW_{C,i}=Σ_{N} BW_{F,j}, where BW_{C,i} represents the bandwidth of the i-th carrier and BW_{F,j} represents the bandwidth of the j-th carrier frequency.

Furthermore, the carrier may be mapped to more than one carrier frequencies. In such cases, the carrier corresponds to more than one different frequency ranges. A part of collection of subcarriers of the carrier are mapped to the frequency range of one of the more than one carrier frequencies and another part of collection of subcarriers of the carrier are mapped to the frequency range of another one of the more than one carrier frequencies. Each subcarrier of the carrier corresponds to an absolute frequency. The subcarriers of the carrier mapped to one of the more than one carrier frequencies corresponds to an absolute center frequency. The subcarriers of the carrier mapped to one of the more than one carrier frequencies corresponds to one or more frequency bands.

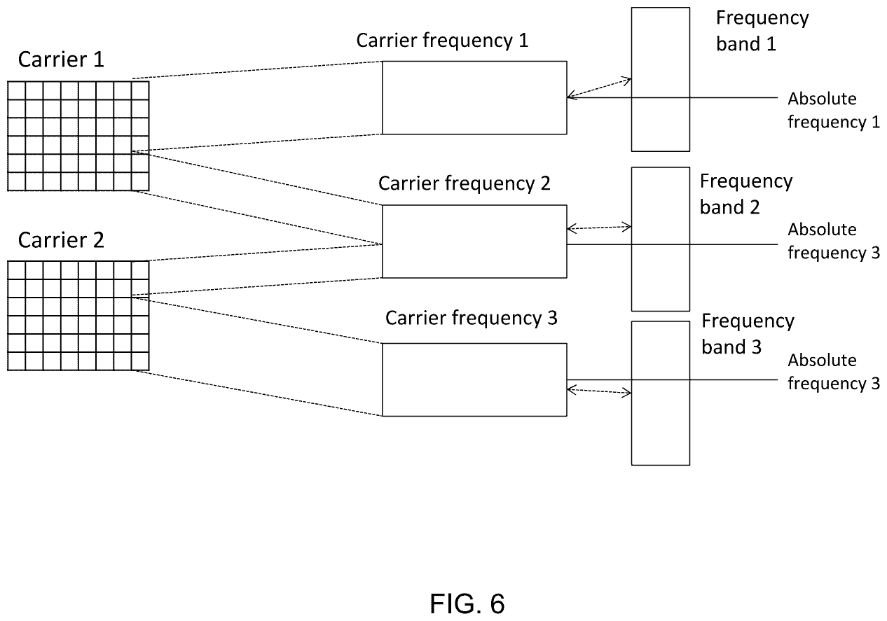

FIG. 6 shows an example of mapping from two carriers to three carrier frequencies. The first part of collection of subcarriers of carrier 1 is mapped to carrier frequency 1, the second part of collection of subcarriers of carrier 1 is mapped to carrier frequency 2. The first part of collection of subcarriers of carrier 2 is mapped to carrier frequency 2, the second part of collection of subcarriers of carrier 2 is mapped to carrier frequency 3. Carrier 1 and carrier 2 share the frequency range of carrier frequency 2. The bandwidth of carrier 1 is equal to the sum of the bandwidth of carrier frequency 1 and the bandwidth of the part of carrier frequency 2 mapped by carrier 1, and the bandwidth of carrier 2 is equal to the sum of the bandwidth of carrier frequency 3 and the bandwidth of the part of carrier frequency 2 mapped by carrier 2.

For example, a carrier with a subcarrier spacing of 30 KHz and a bandwidth of 100 M corresponds to four carrier frequencies: 730 MHz-740 MHz, 791 MHz-821 MHz, 869 MHz-894 MHz, and 925 MHz-960 MHz.

Some embodiments may use the first radio resource control information element (RRC IE) configuration method as follows:

The configuration information of the carrier includes: the carrier index field is configured to be 1; the subcarrier spacing field is configured to be 30 KHz; the carrier bandwidth field is configured to be 100 M; the corresponding carrier frequency index list field is configured to be 1, 2, 3, and 4.

The configuration information of the first carrier frequency includes: the carrier frequency index field is configured as 1; the absolute frequency point field is configured as 735 MHz; the carrier frequency bandwidth field is configured as 10 MHz; the corresponding frequency band list field is configured as n12.

The configuration information of the second carrier frequency includes: the carrier frequency index field is configured to be 2; the absolute frequency point field is configured to be 806 MHz; the carrier frequency bandwidth field is configured to be 30 MHz; the corresponding frequency band list field is configured to be n20.

The configuration information of the third carrier frequency includes: the carrier frequency index field is configured to 3; the absolute frequency field is configured to 882 MHz; the carrier frequency bandwidth field is configured to 25 MHz; the corresponding frequency band list field is configured to n5.

The configuration information of the fourth carrier frequency includes: the carrier frequency index field is configured to 4; the absolute frequency point field is configured to 943 MHz; the carrier frequency bandwidth field is configured to 35 MHz; the corresponding frequency band list field is configured to n8.

The UE obtains the above-mentioned five configuration information, and configures carrier 1 with a subcarrier spacing of 30 KHz and a bandwidth of 100 MHz corresponds to carrier frequency 1 with a bandwidth of 10 MHz, carrier frequency 2 with a bandwidth of 30 MHz, carrier frequency 3 with a bandwidth of 25 MHz, and carrier frequency 4 with a bandwidth of 35 MHz. Therefore absolute frequency ranges corresponding to the carrier are 730 MHz-740 MHz, 791 MHz-821 MHz, 869 MHz-894 MHz, and 925 MHz-960 MHz, and the corresponding frequency band indication indexes are n12, n20, n5, and n8.

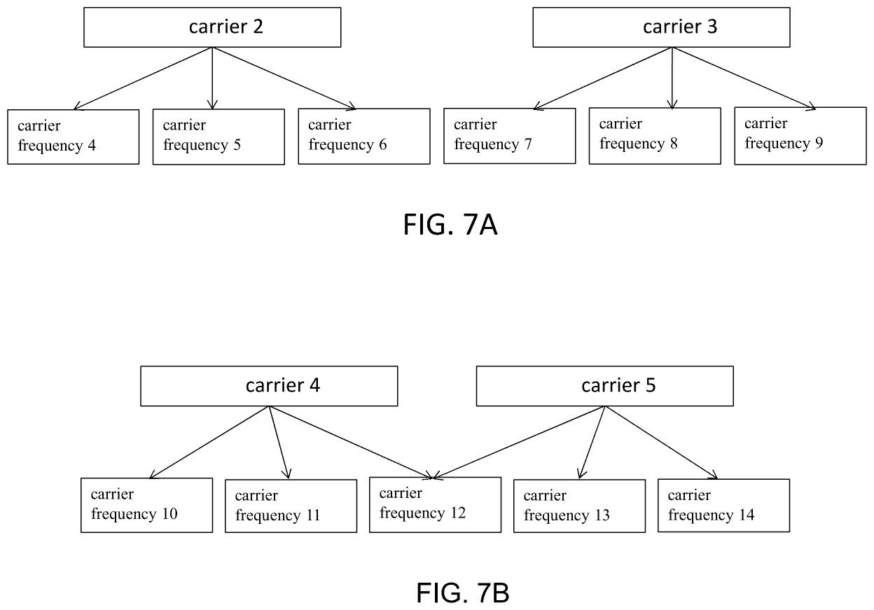

FIG. 7A and FIG. 7B are two examples showing the correspondence between carriers and carrier frequencies. FIG. 7A shows two carriers: carrier 2 and carrier 3, respectively corresponding to three carrier frequencies: carrier 2 corresponds to carrier frequency 4, carrier frequency 5, and carrier frequency 6; carrier 3 corresponds to carrier frequency 7, carrier frequency 8, and carrier frequency 9. FIG. 7B also shows two carriers respectively correspond to three carrier frequencies, but the difference is that the two carriers are mapped to the same carrier frequency, carrier frequency 12. In particular, carrier 4 corresponds to carrier frequency 10, carrier frequency 11, and carrier frequency 12; carrier 5 corresponds to carrier frequency 12, carrier frequency 13, and carrier frequency 14.

### Embodiment 2

This embodiment mainly provides a method in which one first carrier corresponds to more than one second carriers, and one or more second carriers correspond to one or more carrier frequencies. bandwidth of the first carrier is equal to the sum of the bandwidth of more than one second carriers, is equal to the sum of the bandwidth of multiple carrier frequencies, which improves spectrum efficiency, and solves the problem of low transmission efficiency of fragmented spectrum.

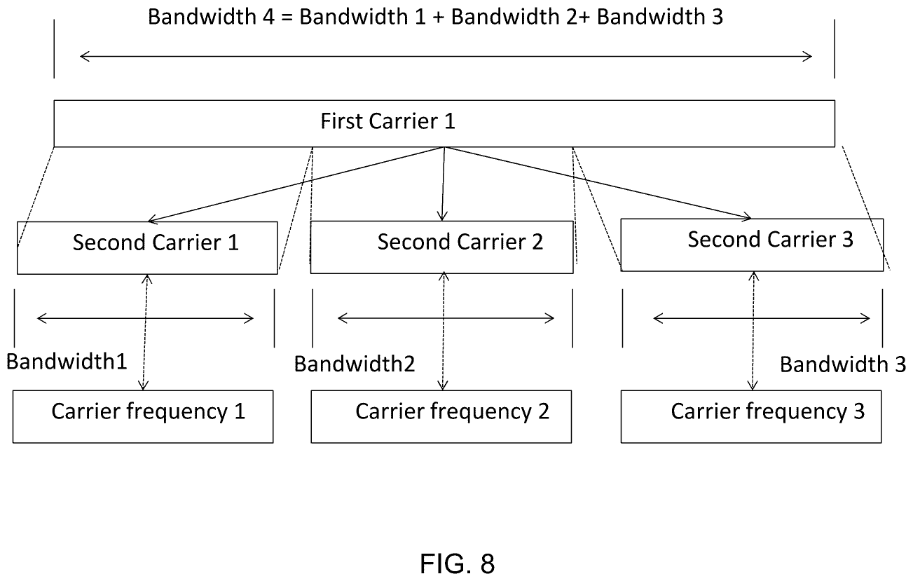

FIG. 8 is a schematic diagram of a first carrier corresponding to three second carriers, each second carrier corresponding to a carrier frequency, the first carrier 1 corresponds to the second carrier 1, the second carrier 2, and the second carrier 3; bandwidth 4 (The bandwidth of the first carrier 1) is equal to the sum of bandwidth 1 (the bandwidth of the second carrier 1), bandwidth 2 (the bandwidth of the second carrier 2), and bandwidth 3 (the bandwidth of the second carrier 3). The second carrier 1, the second carrier 2, and the second carrier 3 respectively correspond to carrier frequency 1, carrier frequency 2, and carrier frequency 3. The bandwidth of second carrier 1 is equal to that of carrier frequency 1, and the bandwidth of second carrier 2 is equal to that of carrier frequency 2. The bandwidth of the second carrier 3 is equal to that of the carrier frequency 3.

The first carrier includes one collection of subcarriers with a subcarrier spacing, and the first carrier corresponds to a reference subcarrier spacing. Each collection of subcarriers corresponds to a subcarrier spacing configuration μ, which is used to indicate the subcarrier spacing of the collection of subcarriers. The subcarrier spacing configuration can be 0, 1, 2, . . . which respectively represent multiples of the reference sub-carrier spacing. Each subcarrier of the first carrier corresponds to one RE, and 12 REs correspond to one RB. Like this, the first carrier includes one or more RE collections or RB collections.

The second carrier includes one or more collections of subcarriers with different subcarrier spacings, and the second carrier corresponds to a reference subcarrier spacing. Each collection of subcarriers corresponds to a subcarrier spacing configuration μ, which is used to indicate the subcarrier spacing of the collection of subcarriers. The subcarrier spacing configuration μ can be 0, 1, 2, . . . , which respectively represent multiples of the reference subcarrier spacing. Each subcarrier of the second carrier corresponds to one RE, and 12 REs correspond to one RB. Like this, the second carrier includes one or more RE collections or RB collections.

The first carrier is associated with one resource grid. The subcarriers of the resource grid are mapped to the subcarriers of the first carrier. The information on the RE of the resource grid is mapped to the RE of the first carrier, and the information on the RB of the resource grid is mapped to the RB of the first carrier. The first carrier is associated with one or more BWPs. The subcarriers of the BWP are mapped to the subcarriers of the first carrier. The information on the RE or RB of the BWP is mapped to the RE or RB of the first carrier. The first carrier is associated with baseband processing, such as resource mapping. Radio resources associated with baseband processing can be mapped to the REs or RBs of first carrier. For example, physical channels and/or physical reference signals are mapped to REs or RBs of the first carrier; or physical channels and/or physical reference signals are mapped to REs or RBs of the resource grid, and information on the REs or RBs of the resource grid is remapped To the RE or RB of the first carrier; or the physical channels and/or physical reference signals are mapped to the REs or RBs of the BWP, and the information on the RE or RB of the BWP is then mapped to the RE or RB of the first carrier; or physical The channel and/or physical reference signal is mapped to the RE or RB of the BWP, the information on the RE or RB of the BWP is then mapped to the RE or RB of the resource grid, and the information on the RE or RB of the resource grid is then mapped to the RE or RB of the first carrier.

The second carrier is associated with one resource grid. The subcarriers of the resource grid are mapped to the subcarriers of the second carrier. The information on the RE of the resource grid is mapped to the RE of the second carrier, and the information on the RB of the resource grid is mapped to the RB of the second carrier. The second carrier is associated with one or more BWPs. The subcarriers of the BWP are mapped to the subcarriers of the second carrier. The information on the RE or RB of the BWP is mapped to the RE or RB of the second carrier. The second carrier is associated with baseband processing, such as resource mapping. Radio resources associated with baseband processing can be mapped to the REs or RBs of second carrier. For example, physical channels and/or physical reference signals are mapped to REs or RBs of the second carrier; or physical channels and/or physical reference signals are mapped to REs or RBs of the resource grid, and information on the REs or RBs of the resource grid is remapped To the RE or RB of the second carrier; or the physical channels and/or physical reference signals are mapped to the REs or RBs of the BWP, and the information on the RE or RB of the BWP is then mapped to the RE or RB of the second carrier; or physical The channel and/or physical reference signals are mapped to the RE or RB of the BWP, the information on the RE or RB of the BWP is then mapped to the RE or RB of the resource grid, and the information on the RE or RB of the resource grid is then mapped to the RE or RB of the second carrier.

The carrier frequency corresponds to an absolute frequency range, such as 2450 MHz to 2550 Mhz. The carrier frequency corresponds to an absolute frequency and a bandwidth, for example, the absolute frequency is 2.6 GHz and the bandwidth is 100 MHz.

In this embodiment, one first carrier corresponds to more than one second carrier. One subcarrier of the first carrier corresponds to one subcarrier of one of the more than one second carriers. One part of collection of subcarriers of the first carrier corresponds to collection of subcarriers of one of the more than one second carriers, another part of collection of subcarriers of the first carrier corresponds to collection of subcarriers of another one of the more than one second carriers. The first carrier may correspond to a second carrier with the same subcarrier spacing, or may correspond to a second carrier with a different subcarrier spacing. The one first carrier is mapped to the more than one second carrier, and one subcarrier of the first carrier is mapped to one subcarrier of one of the more than one second carriers. One part of collection of subcarriers of the first carrier is mapped to collection of subcarriers of one of the more than one second carriers, another part of collection of subcarriers of the first carrier is mapped to collection of subcarriers of another one of the more than one second carriers. The first carrier may be mapped to a second carrier with the same subcarrier spacing, or may be mapped to a second carrier with a different subcarrier spacing. The bandwidth of a first carrier is equal to the sum of the bandwidths of the more than one second carriers.

In some embodiments, one or more second carriers corresponds to one or more carrier frequencies. Each subcarrier of the second carrier corresponds to an absolute frequency. The second carrier is mapped to the corresponding carrier frequencies. Each subcarrier of the second carrier is mapped to an absolute frequency. For the case where one second carrier corresponds to one carrier frequency, the bandwidth of the second carrier is equal to the bandwidth of the corresponding carrier frequency; for the case where one second carrier corresponds to multiple carrier frequencies, the bandwidth of the second carrier is equal to the sum of the bandwidth of the corresponding carrier frequencies.

For example, one first carrier corresponds to two second carriers, and the two second carriers respectively correspond to two carrier frequencies. The two carrier frequencies are 2450 MHz to 2480 MHz and 2500 MHz to 2530 MHz. The first carrier corresponds to these two second carriers and the first carrier is mapped to these two second carriers. The first second carrier corresponds to the first carrier frequency, and the second second carrier corresponds to the second carrier frequency. The first second carrier is mapped to the first carrier frequency, and the second second carrier is mapped to the second carrier frequency. Therefore, the absolute frequency range corresponding to the first second carrier is 2450 MHz to 2480 MHz, and the absolute frequency range corresponding to the second second carrier is 2500 MHz to 2530 MHz. Therefore, the first carrier corresponds to two absolute frequency ranges: 2450 MHz to 2480 MHz and 2500 MHz to 2530 MHz. The bandwidths of the two second carriers are respectively equal to the bandwidths of the two carrier frequencies, 30 MHz and 30 MHz; the bandwidth of the first carrier is equal to the sum of the bandwidths of the two second carriers, 30 MHz+30 MHz=60 MHz.

At present, due to auction-style spectrum resource allocation methods and re-cultivation of spectrum resources occupied by 2G/3G networks, there are a large number of fragmented spectrum resources, especially FDD spectrum. The bandwidth of most spectrum resources is not larger over 30 M, the fragmentation of the spectrum reduces the efficiency of the use of spectrum resources. According to the method of this scheme, a carrier can work on more than one fragmented spectrums at the same time. One first carrier corresponds to more than one second carriers, and each second carrier corresponds to a carrier frequency with a small bandwidth. The bandwidth of the first carrier is equal to the sum of the bandwidths of these second carriers, which is equal to the sum of the bandwidths of these carrier frequencies. A first carrier with a larger bandwidth is formed, which improves the use efficiency of spectrum resources.

For example, if a first carrier corresponds to 10 second carriers, and these 10 second carriers respectively correspond to 10 carrier frequencies with a bandwidth of 10 MHz, then the bandwidth of the first carrier is equal to the sum of the bandwidths of the10 second carriers, which is equal to the sum of the bandwidths of the 10 carrier frequencies, which is equal to 100 M.

For a transmitting communication node such as a base station or a terminal, the mapping from the first carrier to the second carrier may be implemented in a module responsible for baseband processing, and the baseband processing includes but is not limited to: resource mapping. In this module, the first carrier is mapped to the more than one second carriers, and the information on the first carrier is also mapped to the corresponding second carriers.

For a transmitting communication node such as a base station or a terminal, the mapping of the second carriers to the carrier frequencies can be implemented in the module responsible for radio frequency processing, the radio frequency processing includes but not limited to: filtering, digital signal and analog signal conversion, power amplification, frequency shifting. In this module, signal on the second carriers from the module responsible for baseband processing is mapped to corresponding carrier frequencies, and each of the carrier frequency corresponds to an absolute center frequency point, a bandwidth, and a frequency band.

For example, In the module responsible for baseband processing, a first carrier is mapped to two second carriers, and a physical channel mapped on the first carrier is mapped to the two second carriers. In the module responsible for radio frequency processing, the two second carriers and the physical channel from the module responsible for baseband processing, are mapped to the corresponding two carrier frequencies. Like this, a physical channel is transmitted on two different carrier frequencies, that is, one physical channel is transmitted on two different frequency ranges. The two frequency ranges can be adjacent, non-adjacent, or overlapping.

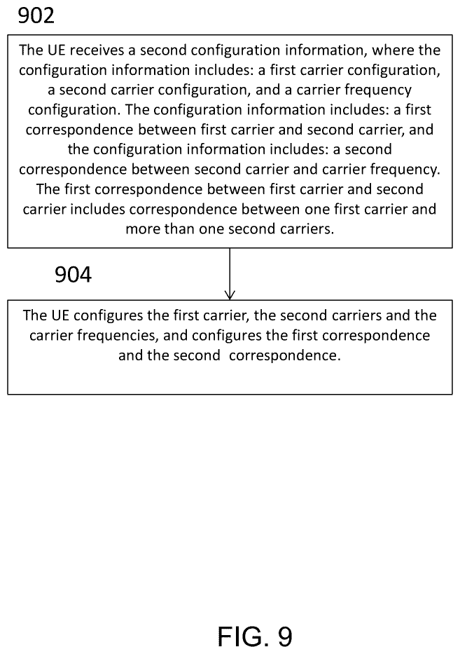

FIG. 9 is a flowchart of the UE side processing of the method of wireless communication, and the steps include:

Step 1 (902): The UE receives a second configuration information, where the configuration information includes: a first carrier configuration, a second carrier configuration, and a carrier frequency configuration. The configuration information includes: a first correspondence between first carrier and second carrier, and the first correspondence may be in the first carrier configuration information, in the second carrier configuration information, or separately indicated. The configuration information also includes: a second correspondence between second carrier and carrier frequency, and the second correspondence may be in the second carrier configuration information, in the carrier frequency configuration information, or separately indicated.

The first correspondence between first carrier and second carrier includes correspondence between one first carrier and more than one second carriers, or correspondence between multiple first carriers and multiple second carriers.

For the case where one first carrier corresponds to more than one second carriers, the bandwidth of one first carrier is equal to the sum of the bandwidths of the more than one second carriers: BW_{SC}=ΣBW_{TC,j}, where BW_{SC} represents the bandwidth of the first carrier and BW_{TC,j} represents the bandwidth of the j-th second carrier.

For the case of M1 first carriers corresponding to N1 second carriers with 1≤M1≤N1. The sum of the bandwidths of M1 carriers is equal to the sum of the bandwidths of N1 carriers: Σ_{M1} BW_{SC,i}=Σ_{N1} BW_{TC,j} where BW_{SC,i} represents the bandwidth of the i-th first carrier and BW_{TC,j} represents the bandwidth of the j-th second carrier.

The second correspondence between second carrier and carrier frequency includes: one second carrier corresponding to one carrier frequency; or one second carrier corresponding to multiple carrier frequencies. The bandwidth of one second carrier is equal to the bandwidth of one carrier frequency or the bandwidth of one second carrier is equal to the sum of the bandwidths of multiple carrier frequencies.

In the prior art, one carrier corresponds to one or more frequency band information and a frequency domain reference point PointA. The carrier configuration includes a frequency domain offset relative to the frequency domain reference point PointA, a bandwidth, and a subcarrier spacing. The frequency domain information configuration includes frequency band list, frequency domain reference point PointA, and a list of carrier configuration. In this way, the carrier, the frequency band, and the frequency domain reference point PointA have a corresponding relationship.

For example:

Resource Control Information Unit (RRC IE) FrequencyInfoDL:
FrequencyInfoDL ::= SEQUENCE {
frequencyBandList
absoluteFrequencyPointA
scs-SpecificCarrierList
...},

where frequencyBandList represents the frequency bands corresponding to the carrier; absoluteFrequencyPointA represents the frequency domain position of the frequency domain reference point PointA, which is represented by ARFCN here; scs-SpecificCarrierList represents the list of carrier configuration.

Resource Control Information Unit (RRC IE) SCS-SpecificCarrier:
SCS-SpecificCarrier ::= SEQUENCE {
offsetToCarrier
subcarrierSpacing
carrierBandwidth
...},

where SCS-SpecificCarrier represents the configuration of the carrier; offsetToCarrier represents the frequency domain offset between the carrier and the frequency domain reference point PointA, thereby determining the frequency domain position of the carrier; subcarrierSpacing represents the subcarrier spacing of the carrier; carrierBandwidth represents the bandwidth of the carrier. ARFCN is absolute radio frequency channel number.

In some embodiments, the first carrier configuration includes: a first carrier index, subcarrier spacing, and bandwidth. The second carrier configuration includes: a second carrier index, subcarrier spacing, and bandwidth. The configuration of the carrier frequency includes: a carrier frequency index, an absolute frequency point in ARFCN, a bandwidth, and a list of corresponding frequency bands.

The first correspondence configuration includes: the configuration of the first carrier includes the index of the second carrier, the configuration of the first carrier includes the configuration of the second carrier, the configuration of the second carrier includes the index of the first carrier, or one configuration information includes the first carrier index and the second carrier index.

The second correspondence configuration includes: the configuration of the second carrier includes the index of the carrier frequency, the configuration of the second carrier includes the configuration of the carrier frequency; the configuration of the carrier frequency includes the index of the second carrier, or one configuration information includes the second carrier index and the carrier frequency index.

The configuration of the first carrier, the configuration of the second carrier, the configuration of the carrier frequency, the configuration of the correspondence between the first carrier and the second carrier, and the configuration of the correspondence between the second carrier and the carrier frequency in this embodiment can be represented by radio resource control information unit (RRC IE), including at least one of the following methods:

### Method 2.1:

The first radio resource control information element (RRC IE) represents the configuration information of the first carrier, including: first carrier index, the first carrier sub-carrier spacing; first carrier bandwidth, and a list of corresponding second carrier indexes. The second radio resource control information element (RRC IE) represents the configuration information of the second carrier, including: second carrier index, sub-carrier spacing of the second carrier, second carrier bandwidth, and corresponding carrier frequency index. The third radio resource control information element (RRC IE) represents carrier frequency configuration information, including: carrier frequency index, absolute frequency, carrier frequency bandwidth; and a list of corresponding frequency bands.

First carrier configuration :: = SEQUENCE {
first carrier index INTEGER (1..maximum number of carrier index)
first carrier subcarrier spacing ENUMERATED {kHz15, kHz30, kHz60, kHz120, kHz240,
spare3, spare2, spare1}
first carrier bandwidth INTEGER (1..maximum number of RB)
corresponding second carrier index list SEQUENCE (SIZE (1: maximum number of carrier
index)) OF carrier index
}
Second carrier configuration:: = SEQUENCE {
second carrier index INTEGER (1..maximum number of carrier index)
second carrier subcarrier spacing ENUMERATED {kHz15, kHz30, kHz60, kHz120, kHz240,
spare3, spare2, spare1}
second carrier bandwidth INTEGER (1..maximum number of RB)
corresponding carrier frequency index list SEQUENCE (SIZE (1: maximum number of carrier
frequency index)) OF carrier frequency index
}
Carrier frequency configuration:: = SEQUENCE {
carrier frequency index INTEGER (1..maximum number of carrier frequency index);
absolute frequency ARFCN-Value
carrier frequency bandwidth INTEGER (0..maxValue), unit: Hz
corresponding frequency band list SEQUENCE (SIZE (1.. maximum number of
FreqBandIndicator)) OF FreqBandIndicator;
},

where the first carrier index indicates the index of the first carrier; the second carrier index indicates the index of the second carrier; the first carrier subcarrier spacing indicates the subcarrier spacing of the first carrier; the second carrier subcarrier spacing indicates the subcarrier spacing of the second carrier; the first carrier bandwidth represents the bandwidth of the first carrier; the second carrier bandwidth represents the bandwidth of the second carrier; corresponding second carrier index list represents the second carrier indexes corresponding to the first carrier; corresponding carrier frequency index list indicates the carrier frequency indexes corresponding to the second carrier; the carrier frequency index indicates the index of the carrier frequency; the absolute frequency point indicates the absolute frequency point of the carrier frequency; the carrier frequency bandwidth indicates the bandwidth of the carrier frequency; the corresponding frequency band list indicates the frequency bands corresponding the carrier frequency. ARFCN is absolute radio frequency channel number. FreqBandIndicator represents frequency band indicator, which is used to indicate frequency band. maxValue is maximum value.

### Method 2.2:

The first radio resource control information element (RRC IE) represents the configuration information of the first carrier, including: first carrier index, the first carrier sub-carrier spacing, and first carrier bandwidth. The second radio resource control information element (RRC IE) represents the configuration information of the second carrier, including: second carrier index, sub-carrier spacing of the second carrier, second carrier bandwidth, a list of corresponding first carrier indexes, and a list of corresponding carrier frequency indexes. The third radio resource control information element (RRC IE) represents carrier frequency configuration information, including: carrier frequency index, absolute frequency, carrier frequency bandwidth, and a list of corresponding frequency bands.

Moreover, First carrier configuration :: = SEQUENCE {
first carrier index INTEGER (1..maximum number of carrier index)
first carrier subcarrier spacing ENUMERATED {kHz15, kHz30, kHz60, kHz120, kHz240,
spare3, spare2, spare1}
first carrier bandwidth INTEGER (1..maximum number of RB)
}
Second carrier configuration :: = SEQUENCE {
second carrier index INTEGER (1..maximum number of index of second carrier)
second carrier subcarrier spacing ENUMERATED {kHz15, kHz30, kHz60, kHz120, kHz240,
spare3, spare2, spare1}
second carrier bandwidth INTEGER (1..maximum number of RB)
corresponding first carrier index list SEQUENCE (SIZE (1: maximum number of carrier index))
OF carrier index
corresponding carrier frequency index list SEQUENCE (SIZE (1: maximum number of carrier
frequency index)) OF carrier frequency index
}
Carrier frequency configuration:: = SEQUENCE {
carrier frequency index INTEGER (1..maximum number of carrier frequency index);
absolute frequency ARFCN-Value
carrier frequency bandwidth INTEGER (0..maxValue), unit: Hz
corresponding frequency band list SEQUENCE (SIZE (1.. maximum number of
FreqBandIndicator)) OF FreqBandIndicator;
},

where the first carrier index indicates the index of the first carrier; the second carrier index indicates the index of the second carrier; the first carrier subcarrier spacing indicates the subcarrier spacing of the first carrier; the second carrier subcarrier spacing indicates the subcarrier spacing of the second carrier; the first carrier bandwidth represents the bandwidth of the first carrier; the second carrier bandwidth represents the bandwidth of the second carrier; the corresponding first carrier index list represents indexes of the first carrier corresponding to the second carrier; carrier frequency index list indicates indexes of the carrier frequency; the absolute frequency point represents the absolute frequency point of the carrier frequency; the carrier frequency bandwidth represents the bandwidth of the carrier frequency; the corresponding frequency band list represents the frequency bands corresponding to the carrier frequency.ARFCN is absolute radio frequency channel number. FreqBandIndicator represents frequency band indicator, which is used to indicate frequency band. maxValue is maximum value.

### Method 2.3:

The first radio resource control information element (RRC IE) represents the configuration information of the first carrier, including: first carrier index, the first carrier sub-carrier spacing, and first carrier bandwidth. The second radio resource control information element (RRC IE) represents the configuration information of the second carrier, including: second carrier index, sub-carrier spacing of the second carrier, second carrier bandwidth, and a list of corresponding carrier frequency indexes. The third radio resource control information element (RRC IE) represents carrier frequency configuration information, including: carrier frequency index, absolute frequency, carrier frequency bandwidth, and a list of corresponding frequency bands. The fourth radio resource control information element (RRC IE) indicates the configuration information of the correspondence between the first carrier and the second carrier, including a list, each element in the list is mainly composed of two parts: a first carrier index, and a list of the second carrier indexes.

Moreover,

First carrier configuration:: = SEQUENCE {
first carrier index INTEGER (1..maximum number of carrier index)
first carrier subcarrier spacing ENUMERATED {kHz15, kHz30, kHz60, kHz120, kHz240,
spare3, spare2, spare1}
first carrier bandwidth INTEGER (1..maximum number of RB)
}
Second carrier configuration:: = SEQUENCE {
second carrier index INTEGER (1..maximum number of carrier index)
second carrier subcarrier spacing ENUMERATED {kHz15, kHz30, kHz60, kHz120, kHz240,
spare3, spare2, spare1 }
second carrier bandwidth INTEGER (1..maximum number of RB)
corresponding carrier frequency index list SEQUENCE (SIZE (1.. maximum number of carrier
frequency index)) OF carrier frequency index
}
Carrier frequency configuration:: = SEQUENCE {
carrier frequency index INTEGER (1..maximum number of carrier frequency index);
absolute frequency ARFCN-Value
carrier frequency bandwidth INTEGER (0..maxValue), unit: Hz
corresponding frequency band list SEQUENCE (SIZE (1..maximum number of
FreqBandIndicator)) OF FreqBandIndicator;
}
Correspondence between first carrier and second carrier list:: = SEQUENCE (SIZE
(1..maximum number of Correspondence between first carrier and second carrier)) OF
Correspondence between first carrier and second carrier;
Correspondence between first carrier and second carrier:: = SEQUENCE{
first carrier index INTEGER (1..maximum number of first carrier index)
second carrier index list SEQUENCE (SIZE (1..maximum number of carrier frequency index))
OF second carrier index
},

where the first carrier index indicates the index of the first carrier; the first carrier subcarrier spacing indicates the subcarrier spacing of the first carrier; the first carrier bandwidth indicates the bandwidth of the first carrier; the second carrier index indicates the index of the second carrier; the second carrier subcarrier spacing indicates the subcarrier spacing of the second carrier; the second carrier bandwidth indicates the bandwidth of the second carrier; the carrier frequency index indicates the index of the carrier frequency; the absolute frequency point indicates the absolute frequency point of the carrier frequency; the carrier frequency bandwidth indicates the bandwidth of the carrier frequency; correspondence between first carrier and second carrier represents the correspondence between the first carrier (indicated by first carrier index) and second carriers (indicated by second carrier index list). correspondence between first carrier and second carrier can be configured to the correspondence between one first carrier and more than one second carriers, which means that one first carrier corresponds to more than one second carriers. correspondence between first carrier and second carrier list can be configured to contain multiple correspondences each of which represents correspondence between one first carrier and more than on second carriers, which means that multiple first carriers corresponds to multiple second carriers. For the case that correspondence between first carrier and second carrier list contains only one correspondence that between one first carrier and more than one second carriers, which means that one first carrier corresponds to more than on second carriers. ARFCN is absolute radio frequency channel number. FreqBandIndicator represents frequency band indicator, which is used to indicate frequency band. maxValue is maximum value.

The first correspondence is configured through RRC messages, and the RRC messages include RRCsetup, RRCReconfiguration, ReconfigurationWithSync, or system messages. The system message includes SIB1.

The second correspondence is configured through RRC messages, and the RRC messages include RRCsetup, RRCReconfiguration, ReconfigurationWithSync, or system messages. The system message includes SIB1.

Furthermore, the system message received by UE in the IDLE state or the INACTIVE state includes the first correspondence, and the RRCsetup and/or RRCReconfiguration received by the UE in the connected state includes the first correspondence. During the cell handover process, the ReconfigurationWithSync received by UE includes the first correspondence. The first correspondence is modified through high-layer signaling, and the high-layer signaling includes RRCReconfiguration.

The system message received by UE in the IDLE state or the INACTIVE state includes the second correspondence, and the RRCsetup and/or RRCReconfiguration received by UE in the connected state includes the second correspondence. During cell handover process, the ReconfigurationWithSync received by UE includes the second correspondence. The second correspondence is modified through high-layer signaling, and the high-layer signaling includes: RRCReconfiguration.

The configuration of the first correspondence includes: UE-level configuration: configure the same first correspondence for all Cells configured for UE; or Cell Group level configuration: each cell group is configured with a first correspondence, all cells of the cell group use the same configured first correspondence, and the first correspondences can be independently configured between Cell Croups; or Cell-level configuration: each cell is configured with a first correspondence, and the first correspondences can be independently configured between the cells.

The configuration of the second correspondence includes: UE-level configuration: configure the same second correspondence for all cells configured for UE; or Cell Group level configuration: each cell group is configured with a second correspondence, all cells of the cell group use the same configured second correspondence, and the second correspondences can be independently configured between cell groups; or Cell-level configuration: for the cells configured for UE, each cell is configured with a second correspondence, and the second correspondences can be independently configured between the cells.

Step 2 (904): The UE configures the first carrier, the second carriers and the carrier frequencies, and configures the first correspondence and the second correspondence.

The first correspondence includes: one first carrier corresponds to more than one second carriers, or M1 first carriers correspond to N1 second carriers, where 1≤M1≤N1.

For the case where one first carrier corresponds to more than one second carriers, the bandwidth of one first carrier is equal to the sum of the bandwidths of more than one second carriers: BW_{SC}=ΣBW_{TC,j} where BW_{SC} represents the bandwidth of the first carrier and BW_{TC,j} represents the bandwidth of the j-th second carrier.

For the case where M1 first carriers correspond to N1 second carriers, the sum of the bandwidths of the M1 first carriers is equal to the sum of the bandwidths of the N1 second carriers: Σ_{M1}BW_{SC,i}=Σ_{N1}BW_{TC,j} where BW_{SC,i} represents the bandwidth of the i-th first carrier and BW_{TC,j} represents the bandwidth of the j-th second carrier.

The second correspondence relationship includes: one second carrier corresponds to one carrier frequency, or one second carrier corresponds to multiple carrier frequencies.

Furthermore, the first carrier is mapped to more than one second carriers. A part of the collection of subcarriers of the first carrier is mapped to one of the corresponding second carriers, and another part of the collection of subcarriers is mapped to another one of the corresponding second carriers. A subcarrier of the first carrier is mapped to a subcarrier of one of the corresponding second carriers. The subcarriers of the second carrier are mapped to the frequency domain range corresponding to the carrier frequency(s): each sub-carrier of the second carrier mapped to the carrier frequency corresponds to an absolute frequency and the sub-carriers of the second carrier mapped to the carrier frequency correspond to an absolute frequency point. The subcarriers of the second carrier mapped to the carrier frequency correspond to one or more frequency band indications.

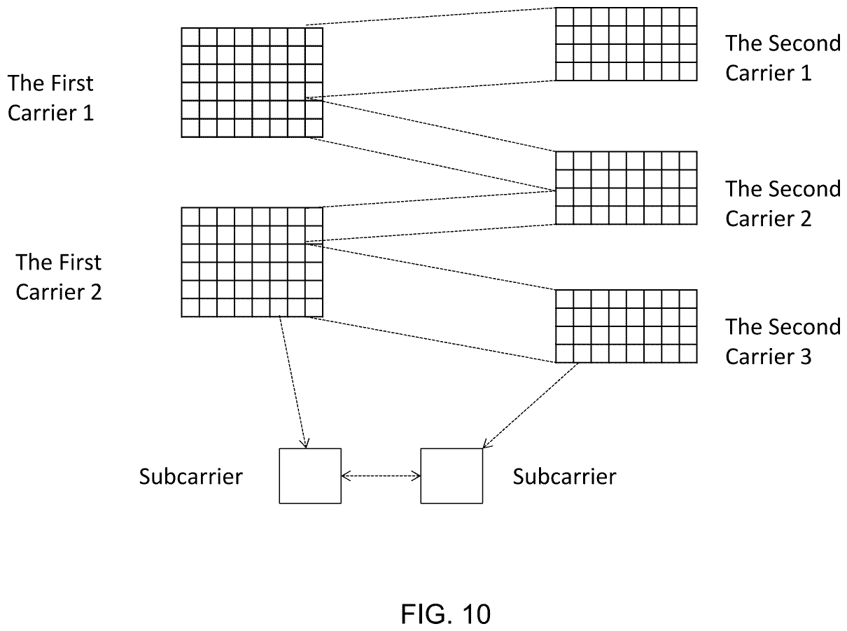

As shown in FIG. 10, it is an example in which two first carriers is mapped to three second carriers. The first part of collection of subcarriers of the first carrier 1 is mapped to the second carrier 1, the second part of collection of subcarriers of the first carrier 1 is mapped to the second carrier 2, and the first part of collection of subcarriers of the first carrier 2 is mapped to the second carrier 2, and the second part of collection of subcarriers of the first carrier 2 is mapped to the second carrier 3. The first carrier 1 and the first carrier 2 share the bandwidth of the second carrier 2. The bandwidth of the first carrier 1 is equal to the sum of the bandwidth of the second carrier 1 and the bandwidth of the part of second carrier 2 mapped by the first carrier 1. The bandwidth of the first carrier 2 is equal to the sum of the bandwidth of the second carrier 3 and the bandwidth of the part of second carrier 2 mapped by the first carrier 2.

For example, a first carrier with a subcarrier spacing of 30 KHz and a bandwidth of 100 M corresponds to four second carriers: a second carrier with subcarrier spacing of 30 KHz and bandwidth of 10 M; a second carrier with subcarrier spacing of 30 KHz and bandwidth of 30 M; a second carrier with subcarrier spacing of 30 KHz and bandwidth of 25 M; and a second carrier with subcarrier spacing of 30 KHz and bandwidth of 35 M. The four second carriers correspond to four carrier frequencies, respectively: 730 MHz-740 MHz, 791 MHz-821 MHz, 869 MHz-894 MHz, and 925 MHz-960 MHz.

Use the first radio resource control information element (RRC IE) configuration method:

The configuration information of the first carrier includes: the carrier index field is configured to be 1; the subcarrier spacing field is configured to be 30 KHz; the carrier bandwidth field is configured to be 100 MHz; the corresponding second carrier index list field is configured to be 1, 2, 3, and 4 respectively.

The configuration information of the first second carrier includes: the carrier index field is configured to be 1; the subcarrier spacing field is configured to be 30 KHz; the carrier bandwidth field is configured to be 10 MHz; the corresponding carrier frequency index list field is configured to be 1.

The configuration information of the second carrier includes: the carrier index field is configured to be 2; the subcarrier spacing field is configured to be 30 KHz; the carrier bandwidth field is configured to be 30 MHz; the corresponding carrier frequency index list field is configured to be 2.

The configuration information of the third second carrier includes: the carrier index field is configured to 3; the subcarrier spacing field is configured to 30 KHz; the carrier bandwidth field is configured to 25 MHz; the corresponding carrier frequency index list field is configured to 3.

The configuration information of the fourth second carrier includes: the carrier index field is configured to 4; the subcarrier spacing field is configured to 30 KHz; the carrier bandwidth field is configured to 35 MHz; the corresponding carrier frequency index list field is configured to 4.

The configuration information of the first carrier frequency includes: the carrier frequency index field is configured as 1; the absolute frequency point field is configured as 735 MHz; the carrier frequency bandwidth field is configured to 10 MHz; the corresponding frequency band list field is configured as n12.

The configuration information of the first carrier frequency includes: the carrier frequency index field is configured to 2; the absolute frequency field is configured to 806 MHz; the carrier frequency bandwidth field is configured to 30 MHz; the corresponding frequency band list field is configured to n20.

The configuration information of the second carrier frequency includes: the carrier frequency index field is configured to 3; the absolute frequency field is configured to 882 MHz; the carrier frequency bandwidth field is configured to 25 MHz; the corresponding frequency band list field is configured to n5.

The configuration information of the fourth carrier frequency includes: the carrier frequency index field is configured to 4; the absolute frequency point field is configured to 943 MHz; the carrier frequency bandwidth field is configured to 35 MHz; the corresponding frequency band list field is configured to n8.

Accordingly, in some embodiments, the UE obtains the above nine configuration information, and configures that the first carrier 1 with a bandwidth of 100 MHz corresponds to a second carrier 1 with a bandwidth of 10 MHz, a second carrier 2 with a bandwidth of 30 MHz, a second carrier 3 with a bandwidth of 25 MHz, and a second carrier 4 with a bandwidth of 35 MHz. The four second carriers respectively correspond to: a carrier frequency 1 with bandwidth of 10 MHz, a carrier frequency 2 with bandwidth of 30 MHz, a carrier frequency 3 with bandwidth of 25 MHz, and a carrier frequency 4 with bandwidth of 35 MHz. Like this, therefore absolute frequency ranges corresponding to the first carrier are 730 MHz-740 MHz, 791 MHz-821 MHz, 869 MHz-894 MHz, and 925 MHz-960 MHz, and the corresponding frequency band indication indexes are n12, n20, n5, and n8.

### Embodiment 3

This embodiment mainly provides a method in which one carrier corresponds to one first carrier frequency, and the first carrier frequency corresponds to more than one second carrier frequencies Bandwidth of the carrier is equal to bandwidth of the first carrier frequency, the bandwidth of which is equal to the sum of bandwidths of the more than one second carrier frequencies. Therefore, the carrier corresponds a larger bandwidth and can transmit a larger transmission block, which improves the spectral efficiency and solves the problem of low transmission efficiency of fragmented carriers.

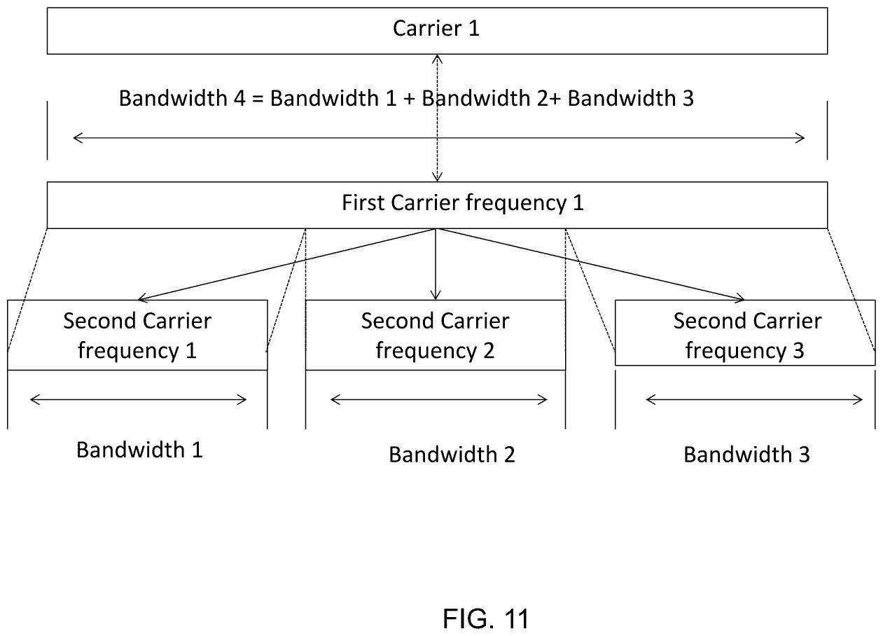

As shown in FIG. 11, one carrier corresponds to one first carrier frequency, and the first carrier frequency corresponds to three second carrier frequencies. The first carrier frequency 1 corresponds to the second carrier frequency 1, the second carrier frequency 2, and the second carrier frequency 3. Bandwidth 4 (the bandwidth of the first carrier frequency 1) is equal to the sum of bandwidth 1 (the bandwidth of the second carrier frequency 1), bandwidth 2 (the bandwidth of the second carrier frequency 2), and bandwidth 3 (the bandwidth of the second carrier frequency 3). Carrier 1 corresponds to the first carrier frequency 1, and the bandwidth of carrier 1 is equal to the bandwidth of the first carrier frequency 1.

The carrier includes one collection of subcarriers with a subcarrier spacing, and the carrier corresponds to a reference subcarrier spacing. Each collection of subcarriers corresponds to a subcarrier spacing configuration μ, which is used to indicate the subcarrier spacing of the collection of subcarriers. The subcarrier spacing configuration μ can be 0, 1, 2, . . . , which respectively represent 2^{μ} multiples of the reference subcarrier spacing. Each subcarrier of the carrier corresponds to one RE, and 12 REs correspond an RB. Like this, the carrier includes one or more RE collections or RB collections.

The carrier is associated with one resource grid. The subcarriers of the resource grid are mapped to the subcarriers of the carrier. The information on the RE of the resource grid is mapped to the RE of the carrier, and the information on the RB of the resource grid is mapped to the RB of the carrier. The carrier is associated with one or more BWPs. The subcarriers of the BWP are mapped to the subcarriers of the carrier. The information on the RE or RB of the BWP is mapped to the RE or RB of the carrier.

A carrier may be associated with baseband processing, such as resource mapping. Radio resources associated with baseband processing can be mapped to the REs or RBs of carrier. For example, physical channels and/or physical reference signals are mapped to REs or RBs of the carrier; or physical channels and/or physical reference signals are mapped to REs or RBs of the resource grid, and information on the REs or RBs of the resource grid is mapped to RE or RB of the carrier; or the physical channel and/or physical reference signals are mapped to the RE or RB of the BWP, and the information on the RE or RB of the BWP is mapped to the RE or RB of the carrier; or the physical channel and/or the physical reference signals are mapped to the RE or RB of the BWP, the information on the RE or RB of the BWP is mapped to the RE or RB of the resource grid, and the information on the RE or RB of the resource grid is mapped to the RE or RB of the carrier.

The first carrier frequency corresponds to a frequency range, corresponding to a frequency domain reference point and a bandwidth, for example, the frequency domain reference point is 1.8 GHz and the bandwidth is 100 M. The second carrier frequency corresponds to an absolute frequency range, such as 2500 MHz to 2550 Mhz. The second carrier frequency corresponds to an absolute center frequency and a bandwidth, for example, the absolute center frequency is 2.6 GHz and the bandwidth is 50 M.

In this embodiment, one first carrier frequency corresponds to more than one second carrier frequencies, and one or more carriers correspond to one or more first carrier frequencies. The first carrier frequency is mapped to the more than one second carrier frequencies. The frequency range of the first carrier frequency is mapped to the frequency ranges of the more than one second carrier frequencies. A part of the frequency range of the first carrier frequency is mapped to the frequency range of one of the more than one second carrier frequencies, and another part of the frequency range of the first carrier frequency is mapped to the frequency range of another one of the more than one second carrier frequencies. The bandwidth of the first carrier frequency is equal to the sum of the bandwidths of the corresponding more than one second carrier frequencies.

One carrier is mapped to the corresponding one first carrier frequency, or one carrier is mapped to multiple carrier frequencies. Subcarriers of the carrier are mapped to frequency range of the first carrier frequency. For the case where one carrier corresponds to one first carrier frequency, the bandwidth of the carrier is equal to the bandwidth of the first carrier frequency; for the case where one carrier corresponds to multiple first carrier frequencies, the bandwidth of the carrier is equal to the sum of the bandwidth of the multiple first carrier frequencies.

For example, one carrier corresponds to one first carrier frequency, and this first carrier frequency corresponds to two second carrier frequencies. The two second carrier frequencies are 2450 MHz to 2480 MHz and 2500 MHz to 2530 MHz, respectively. The first carrier frequency is mapped to the two second carrier frequencies, so that the first carrier frequency corresponds to two different absolute frequency ranges of 2450 MHz to 2480 MHz and 2500 MHz to 2530 MHz, and the bandwidth of the first carrier frequency is equal to the sum of the bandwidths of the two second carrier frequencies, 30 MHz+30 MHz=60 MHz. The carrier is mapped to the first carrier frequency, corresponding to two different frequency ranges of 2450 MHz to 2480 Mhz and 2500 MHz to 2530 Mhz, and a bandwidth of 60 MHz.

At present, due to auction-style spectrum resource allocation methods and re-cultivation of spectrum resources occupied by 2G/3G networks, there are many fragmented spectrum resources, especially FDD spectrum. The bandwidth of most spectrum resources is not larger over 30 M, the fragmentation of the spectrum reduces the efficiency of the use of spectrum resources. According to the method of this scheme, a carrier can work on more than one fragmented frequency spectrum at the same time. One carrier corresponds to one or more first carrier frequencies and each of the first carrier frequencies corresponds to more than one second carrier frequencies with small bandwidths, and the bandwidth of the carrier is equal to the bandwidth of one first carrier frequency or sum of the bandwidths of multiple first carrier frequencies and bandwidths of each first carrier frequency is the sum of the bandwidths of more than one second carrier frequencies. Therefore, a carrier with a larger bandwidth is formed, which improves the use efficiency of spectrum resources.

For example, if one carrier corresponds to one first carrier frequency, and the first carrier frequency corresponds 10 second carrier frequencies, each with a bandwidth of 10 M, the bandwidth of the carrier is equal to the bandwidth of the first carrier frequency, which is equal to the sum of the bandwidths of 10 second carrier frequencies, which is equal to 100 M.

For a transmitting communication nodes such as base stations or terminals, the mapping of the carrier to the second carrier frequency can be implemented in the module responsible for radio frequency processing, radio frequency processing includes but not limited to: filtering, digital signal and analog signal conversion, power amplification, frequency shifting. In the module, the signal on the carrier from the module responsible for baseband processing, is mapped to the corresponding first carrier frequency. The mapping from the first carrier frequency to the second carrier frequencies can be implemented in the module responsible for radio frequency processing. Multiple filters may be used for mapping the first carrier frequency to more than one second carrier frequencies. Other methods can also be used for mapping the first carrier frequency to the corresponding more than one second carrier frequencies. For example, In the module responsible for radio frequency processing, a carrier is mapped to a first carrier frequency, and a physical channel mapped on the carrier is also mapped to the first carrier frequency. The first carrier frequency and the mapped physical channel are mapped to two second carrier frequencies. In this way, one physical channel can be transmitted on two different carrier frequencies, that is, one physical channel can be transmitted on two different frequency ranges. The two frequency ranges can be adjacent, non-adjacent, or overlapping.

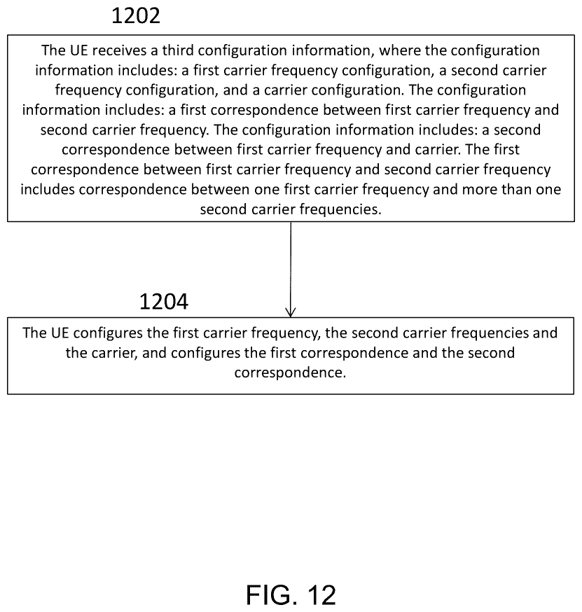

FIG. 12 is a flowchart of processing on the UE side of the method of the present invention in this embodiment, where the steps include:

Step 1 (1202): The UE receives a third configuration information, where the configuration information includes: a first carrier frequency configuration, a second carrier frequency configuration, and a carrier configuration.

The configuration information includes: a first correspondence between first carrier frequency and second carrier frequency. The first correspondence may be in the first carrier frequency configuration information, in the second carrier frequency configuration information, or separately indicated.

The configuration information includes: a second correspondence between first carrier frequency and carrier. The second correspondence may be in the carrier configuration information, in the first carrier frequency configuration information, or separately indicated.

The first correspondence between first carrier frequency and second carrier frequency includes correspondence between one first carrier frequency and more than one second carrier frequencies, or multiple first carrier frequencies and multiple second carrier frequencies.

For the case where one first carrier frequency corresponds to more than one second carrier frequencies, the bandwidth of one first carrier frequency is equal to the sum of the bandwidths of more than one second carrier frequencies: BW_{SF}=ΣBW_{TF,j} where BW_{SF} represents the bandwidth of the first carrier frequency and BW_{TF,j} represents the bandwidth of the j-th second carrier frequency.

For the M2 first carrier frequencies corresponding to N2 second carrier frequencies with 1≤M2≤N2, the sum of the bandwidths of the M2 first carrier frequencies is equal to the sum of the bandwidths of the N2 second carrier frequencies: Σ_{M2}BW_{SF,i}=Σ_{N2}BW_{TF,j}, where BW_{SF,i} represents the bandwidth of the i-th first carrier frequency and BW_{TF,j} represents the bandwidth of the j-th second carrier frequency.

The second correspondence between the carrier and the first carrier frequency is that one carrier corresponds to one or more first carrier frequencies. The bandwidth of the carrier is equal to the bandwidth of the first carrier frequency, or the bandwidth of the carrier is equal to the sum of the bandwidth of the multiple first carrier frequencies.

In the prior art, the carrier corresponds to one or more frequency band information and a frequency domain reference point PointA. The carrier configuration includes a frequency domain offset relative to the frequency domain reference point PointA, a bandwidth, and a subcarrier spacing. The frequency domain information configuration includes: a frequency band list, a frequency domain reference point PointA, and a carrier configuration list. In this way, the carrier, the frequency band, and the frequency domain reference point PointA have a corresponding relationship.

For example:

Resource Control Information Unit (RRC IE) FrequencyInfoDL:
Frequency InfoDL ::= SEQUENCE {
frequencyBandList
absoluteFrequencyPointA
scs-SpecificCarrierList
...}

where frequencyBandList represents the frequency bands corresponding to the carrier; absoluteFrequencyPointA represents the frequency domain position of the frequency domain reference point PointA, which is represented by ARFCN here; scs-SpecificCarrierList represents a list of carrier configuration.

Resource Control Information Unit (RRC IE) SCS-SpecificCarrier:
SCS-SpecificCarrier ::= SEQUENCE {
offsetToCarrier
subcarrierSpacing
carrierBandwidth
...},

where SCS-SpecificCarrier represents the configuration of the carrier; offsetToCarrier represents the frequency domain offset between the carrier and the frequency domain reference point PointA, thereby determining the frequency domain position of the carrier; subcarrierSpacing represents the subcarrier spacing of the carrier; carrierBandwidth represents the bandwidth of the carrier. ARFCN is absolute radio frequency channel number. FreqBandIndicator represents frequency band indicator, which is used to indicate frequency band

In some embodiments, the carrier configuration includes: carrier index, sub-carrier spacing, and bandwidth. The configuration of the first carrier frequency includes: a first carrier frequency index, a frequency domain reference point PointA, and a bandwidth. The configuration of the second carrier frequency includes: the second carrier frequency index, the absolute center frequency point, the bandwidth, and the corresponding frequency bands.

The first correspondence configuration includes: the configuration of the first carrier frequency includes the index of the second carrier frequency, or the configuration of the first carrier frequency includes the configuration of the second carrier frequency, or the configuration of the second carrier frequency includes the index of the first carrier frequency, or one configuration information includes the first carrier frequency index and the second carrier frequency index.

The second correspondence configuration includes: the carrier configuration includes the index of the first carrier frequency, or the configuration of the carrier includes the configuration of the first carrier frequency, or the configuration of the first carrier frequency includes the index of the carrier, or one configuration information includes a carrier index and a first carrier frequency index.

In this embodiment, the configuration of the first carrier frequency, the configuration of the second carrier frequency, the carrier configuration, the configuration of the first correspondence between the first carrier frequency and the second carrier frequencies, the configuration of the second correspondence between the carrier and the first carrier frequency, can be represented by resource control information element (RRC IE), including at least one of the following methods:

### Method 3.1:

The first radio resource control information element (RRC IE) represents the configuration information of the first carrier frequency, including: the first carrier frequency index, frequency domain reference point PointA, the first carrier frequency bandwidth, and a list of corresponding second carrier frequency indexes. The second radio resource control information element (RRC IE) represents the configuration information of the second carrier frequency, including: the second carrier frequency index, absolute frequency, the second carrier frequency bandwidth, and a list of corresponding frequency bands.

The third radio resource control information element (RRC IE) represents carrier configuration information, including: carrier index, subcarrier spacing, carrier bandwidth, and a list of corresponding first carrier frequency indexes.

Furthermore,

First carrier frequency configuration:: = SEQUENCE {
first carrier frequency index INTEGER (1..maximum number of carrier frequency index)
frequency domain reference point PointA ARFCN-Value
first carrier frequency bandwidth INTEGER (0..maxValue), unit: Hz
corresponding second carrier frequency index list SEQUENCE (SIZE (1: maximum number of
carrier frequency index)) OF carrier frequency index
}
Second carrier frequency configuration:: = SEQUENCE {
second carrier frequency index INTEGER (1..maximum number of carrier frequency index)
absolute frequency ARFCN-Value
second carrier frequency bandwidth INTEGER (0..maxValue), unit: Hz
corresponding frequency band list SEQUENCE (SIZE (1.. maximum number of
FreqBandIndicator)) OF FreqBandIndicator;
}
Carrier configuration:: = SEQUENCE {
carrier index INTEGER (1..maximum number of carrier index);
subcarrier spacing ENUMERATED {kHz15, kHz30, kHz60, kHz120, kHz240, spare3, spare2,
spare 1}
carrier bandwidth INTEGER (1..maximum number of RB)
corresponding first carrier frequency index list SEQUENCE (SIZE (1.. maximum number of
carrier frequency index)) OF carrier frequency index
},

where the first carrier frequency index represents the index of the first carrier frequency; the first carrier frequency bandwidth represents the bandwidth of the first carrier frequency; the corresponding second carrier frequency index list represents the second carrier frequency indexes corresponding to the first carrier frequency; frequency domain reference point PointA represents the absolute frequency of frequency domain reference point; absolute frequency point represents the absolute frequency point of the second carrier frequency; the first carrier frequency bandwidth represents the bandwidth of the first carrier frequency; the second carrier frequency bandwidth represents the bandwidth of the second carrier frequencies; the corresponding frequency band list indicates the frequency bands corresponding to the second carrier frequency; the carrier index indicates the index of the carrier; the subcarrier spacing indicates the subcarrier spacing of the carrier; the corresponding first carrier frequency index list indicates the first carrier frequency indexes corresponding the carrier. ARFCN is absolute radio frequency channel number. FreqBandIndicator represents frequency band indicator, which is used to indicate frequency band. maxValue is maximum value.

### Method 3.2:

The first radio resource control information element (RRC IE) represents the configuration information of the first carrier frequency, including: the first carrier frequency index, frequency domain reference point PointA and the first carrier frequency bandwidth. The second radio resource control information element (RRC IE) indicates the configuration information of the second carrier frequency, including: the second carrier frequency index, absolute frequency, the second carrier frequency bandwidth, list of corresponding frequency bands, and the corresponding first carrier frequency index. The third radio resource control information element (RRC IE) represents carrier configuration information, including, carrier index, subcarrier spacing, carrier bandwidth, and a list of corresponding first carrier frequency index.

Furthermore,

First carrier frequency configuration:: = SEQUENCE {
first carrier frequency index INTEGER (1..maximum number of the index of the first carrier
frequency)
frequency domain reference point PointA ARFCN-Value
first carrier frequency bandwidth INTEGER (0..maxValue), unit: Hz
}
Second carrier frequency configuration:: = SEQUENCE {
second carrier frequency index INTEGER (1..maximum number of carrier frequency index)
absolute frequency ARFCN-Value
second carrier frequency bandwidth INTEGER (0..maxValue), unit: Hz
corresponding frequency band list SEQUENCE (SIZE (1.. maximum number of
FreqBandIndicator)) OF FreqBandIndicator;
corresponding first carrier frequency index INTEGER (1..maximum number of carrier
frequency index)
}
Carrier configuration:: = SEQUENCE {
carrier index INTEGER (1..maximum number of carrier index);
subcarrier spacing ENUMERATED {kHz15, kHz30, kHz60, kHz120, kHz240, spare3, spare2,
spare 1}
carrier bandwidth INTEGER (1..maximum number of RB)
corresponding first carrier frequency index list INTEGER (1..maximum number of carrier
frequency index)
},

where the first carrier frequency index represents the index of the first carrier frequency; the first carrier frequency bandwidth represents the bandwidth of the first carrier frequency; corresponding first carrier frequency index represents the first carrier frequency index corresponding to the second carrier frequency; frequency domain reference point PointA represents the absolute frequency of frequency domain reference point; absolute frequency point represents the absolute frequency point of the second carrier frequency; the first carrier frequency bandwidth represents the bandwidth of the first carrier frequency; the second carrier frequency bandwidth represents the bandwidth of the second carrier frequency; the corresponding frequency band list indicates the frequency bands corresponding to the second carrier frequency; the carrier index indicates the index of the carrier; the subcarrier spacing indicates the subcarrier spacing of the carrier; the corresponding first carrier frequency index list indicates the corresponding first carrier frequency indexes of the carrier. ARFCN is absolute radio frequency channel number. FreqBandIndicator represents frequency band indicator, which is used to indicate frequency band. maxValue is maximum value.

### Method 3.3:

The first radio resource control information element (RRC IE) represents the configuration information of the first carrier frequency, including: the first carrier frequency index, frequency domain reference point PointA, and the first carrier frequency bandwidth. The second radio resource control information element (RRC IE) represents the configuration information of the second carrier frequency, including: the second carrier frequency index, absolute frequency, the second carrier frequency bandwidth, and a list of corresponding frequency bands. The third radio resource control information element (RRC IE) represents carrier configuration information, including: carrier index, subcarrier spacing, carrier bandwidth, and the corresponding first carrier frequency index. The fourth radio resource control information element (RRC IE) represents the configuration information of the correspondence between the first carrier frequency and the second carrier frequencies, including a list, each element in the list is mainly composed of two parts: the first carrier frequency index, and the list of the second carrier frequency index.

Furthermore,

First carrier frequency configuration:: = SEQUENCE {
first carrier frequency index INTEGER (1..maximum number of the index of the first carrier
frequency)
frequency domain reference point PointA ARFCN-Value
first carrier frequency bandwidth INTEGER (0..maxValue), unit: Hz
}
Second carrier frequency configuration:: = SEQUENCE {
second carrier frequency index INTEGER (1..maximum number of carrier frequency index)
absolute frequency ARFCN-Value
second carrier frequency bandwidth INTEGER (0..maxValue), unit: Hz
corresponding frequency band list SEQUENCE (SIZE (1.. maximum number of
FreqBandIndicator)) OF FreqBandIndicator;
}
Carrier configuration:: = SEQUENCE {
carrier index INTEGER (1..maximum number of carrier index);
subcarrier spacing ENUMERATED {kHz15, kHz30, kHz60, kHz120, kHz240, spare3, spare2,
spare 1}
carrier bandwidth INTEGER (1..maximum number of RB)
corresponding first carrier frequency index INTEGER (1..maximum number of carrier frequency
index)
}
Correspondence between first carrier frequency and second carrier frequency list :: =
SEQUENCE (SIZE (1..maximum number of Correspondence between first carrier frequency and
second carrier frequency)) OF Correspondence between first carrier frequency and second carrier
frequency;
Correspondence between first carrier frequency and second carrier frequency:: = SEQUENCE{
first carrier frequency index INTEGER (1..maximum number of carrier frequency index)
second carrier frequency index list SEQUENCE (SIZE (1..maximum number of carrier
frequency index)) OF second carrier frequency index
},

where the first carrier frequency index represents the index of the first carrier frequency; the first carrier frequency bandwidth represents the bandwidth of the first carrier frequency; the frequency domain reference point PointA represents absolute frequency of the frequency domain reference point; the absolute frequency point represents the absolute frequency of the second carrier frequency; the first carrier frequency bandwidth represents the bandwidth of the first carrier frequency; the second carrier frequency bandwidth represents the bandwidth of the second carrier frequency; the corresponding frequency band list represents the frequency bands corresponding to the second carrier frequency; the carrier index represents the index of the carrier; the subcarrier spacing represents the subcarrier spacing of the carrier; the corresponding first carrier frequency index represents the first carrier frequency index corresponding to the carrier; the correspondence between first carrier frequency and second carrier frequency represents the correspondence between the first carrier frequency (indicated by the first carrier frequency index) and the second carrier frequencies (indicated by the second carrier frequency index list).correspondence between first carrier frequency and second carrier frequency can be configured to the correspondence between one first carrier frequency and more than one second carrier frequencies, which means that one first carrier frequency corresponds to more than one second carrier frequencies. The correspondence between first carrier frequency and second carrier frequency list can be configured to contain multiple correspondences, each of which represents correspondence between one first carrier frequency and more than on second carrier frequencies, which means that multiple first carrier frequencies corresponds to multiple second carrier frequencies. For the case that correspondence between first carrier frequency and second carrier frequency list contains only one correspondence that between one first carrier frequency and more than one second carrier frequencies, which means that one first carrier frequency corresponds to more than on second carrier frequencies. ARFCN is absolute radio frequency channel number. FreqBandIndicator represents frequency band indicator, which is used to indicate frequency band

The first correspondence is configured through RRC messages, and the RRC messages include RRCsetup, RRCReconfiguration, ReconfigurationWithSync, or system messages. The system message includes SIB1.

The second correspondence is configured through RRC messages, and the RRC messages include RRCsetup, RRCReconfiguration, ReconfigurationWithSync, or system messages. The system message includes: SIB1.

Furthermore, the system message received by the UE in the IDLE state or the INACTIVE state includes the first correspondence. The RRCsetup and/or RRCReconfiguration received by the UE in the connected state includes the first correspondence. During the cell handover process, the ReconfigurationWithSync received by the UE includes the first correspondence. The first correspondence is modified through high-layer signaling, and the high-layer signaling includes RRCReconfiguration.

The system message received by the UE in the IDLE state or the INACTIVE state includes the second correspondence. The RRCsetup and/or RRCReconfiguration received by the UE in the connected state includes the second correspondence. During the cell handover process, the ReconfigurationWithSync received by the UE includes the second correspondence. The second correspondence is modified through high-layer signaling, and the high-layer signaling includes: RRCReconfiguration.

The configuration of the first correspondence includes: UE-level configuration: UE is configured with a same first correspondence for all configured cells; or cell group level configuration: UE is configured with a first correspondence for each cell group, and all cells of the cell group use the same configured first correspondence, the first correspondences are independently configured between cell groups; or cell-level configuration: UE is configured with a first correspondence for each cell, and the first correspondence can be independently configured between the cells.

The configuration of the second correspondence includes: UE-level configuration: UE is configured with a same second correspondence for all configured cells; or cell group level configuration: UE is configured with a second correspondence for each cell group, and all cells of the cell group use the same configured second correspondence, the second correspondences are independently configured between cell groups; or cell-level configuration: UE is configured with a second correspondence for each cell, and the second correspondence can be independently configured between the cells.

Step 2 (1204): The UE configures the first carrier frequency, the second carrier frequencies and the carrier, and configures the first correspondence and the second correspondence.

The first correspondence includes: one first carrier frequency corresponds to more than one second carrier frequencies, or M2 first carrier frequencies correspond to N2 second carrier frequencies with 1≤M2≤N2.

For the case where one first carrier frequency corresponds to more than one second carrier frequencies, the bandwidth of one first carrier frequency is equal to the sum of the bandwidths of more than one second carrier frequencies: BW_{SF}=ΣBW_{TF,j} where BW_{SF} represents the bandwidth of the first carrier frequency and BW_{TF,j} represents the bandwidth of the j-th second carrier frequency.

For the case where M2 first carrier frequencies correspond to N2 second carrier frequencies, the sum of the bandwidths of the M2 first carrier frequencies is equal to the sum of the bandwidths of the N2 second carrier frequencies: Σ_{M2} BW_{SF,i}=Σ_{N2} BW_{TF,j} where BW_{SF,i} represents the bandwidth of the i-th first carrier frequency and BW_{TF,j} represents the bandwidth of the j-th second carrier frequency.

The second correspondence includes: One or more carriers correspond to one or more second carrier frequencies.

Furthermore, the carrier is mapped to the frequency range of the one or more first carrier frequencies. The sub-carriers of the carrier are mapped to the frequency range of the first carrier frequencies. The frequency range of one first carrier frequency is mapped to the frequency range corresponding to more than one second carrier frequency: a part of the frequency range of the first carrier frequency is mapped to the frequency range of one of the second carrier frequencies, and another part of the frequency range of the first carrier frequency is mapped to the frequency range of another second carrier frequency. The first carrier frequency mapped to the second carrier frequencies corresponds to more than one absolute frequency ranges and the first carrier frequency mapped to the second carrier frequencies corresponds to more than one frequency bands.

For example, a carrier with a subcarrier spacing of 30 KHz and a bandwidth of 100 M corresponds to a first carrier frequency with a bandwidth of 100 M, and the first carrier frequency corresponds to four second carrier frequencies: 730 MHz-740 MHz, 791 MHz-821 MHz, 869 MHz-894 MHz, and 925 MHz-960 MHz.

Some embodiments may use the first radio resource control information element (RRC IE) configuration method. The configuration information of the carrier includes: the carrier index field is configured to be 1; the subcarrier spacing field is configured to be 30 KHz; the carrier bandwidth field is configured to be 100 MHz; the corresponding second carrier frequency list field is configured to be 1.

The configuration information of the first carrier frequency includes: the carrier frequency index field is configured to be 1; the frequency domain reference point field is configured to be 842 MHz; the carrier frequency bandwidth field is configured to be 100 MHz; the corresponding second carrier frequency index list field is configured to be 1, 2, 3, 4.

The configuration information of the first second carrier frequency includes: the carrier frequency index field is configured as 1; the absolute center frequency field is configured as 735 MHz; the carrier frequency bandwidth field is configured as 10 MHz; the corresponding frequency band list field is configured as n12.

The configuration information of the second second carrier frequency includes: the carrier frequency index field is configured to 2; the absolute center frequency field is configured to 806 MHz; the carrier frequency bandwidth field is configured to 30 MHz; the corresponding frequency band list field is configured to n20.

The configuration information of the third second carrier frequency includes: the carrier frequency index field is configured to 3; the absolute center frequency field is configured to 882 MHz; the carrier frequency bandwidth field is configured to 25 MHz; the corresponding frequency band list field is configured to n5.

The configuration information of the fourth second carrier frequency includes: the carrier frequency index field is configured to 4; the absolute center frequency field is configured to 943 MHz; the carrier frequency bandwidth field is configured to 35 MHz; the corresponding frequency band list field is configured to n8.

The UE obtains the above six configuration information and configures that carrier 1 with a bandwidth of 100 MHz corresponds to a first carrier frequency 1 with a bandwidth of 100 MHz. This first carrier frequency corresponds to: the second carrier frequency 1 with a bandwidth of 10 MHz, the second carrier frequency 2 with a bandwidth of 30 MHz, the second carrier frequency 3 with a bandwidth of 25 MHz, and the second carrier frequency 4 with a bandwidth of 35 MHz. Therefore, the absolute frequency range corresponding to the carrier is 730 MHz-740 MHz, 791 MHz-821 MHz, 869 MHz-894 MHz, and 925 MHz-960 MHz, and the frequency band indications corresponding to the carrier are n12, n20, n5, and n8.

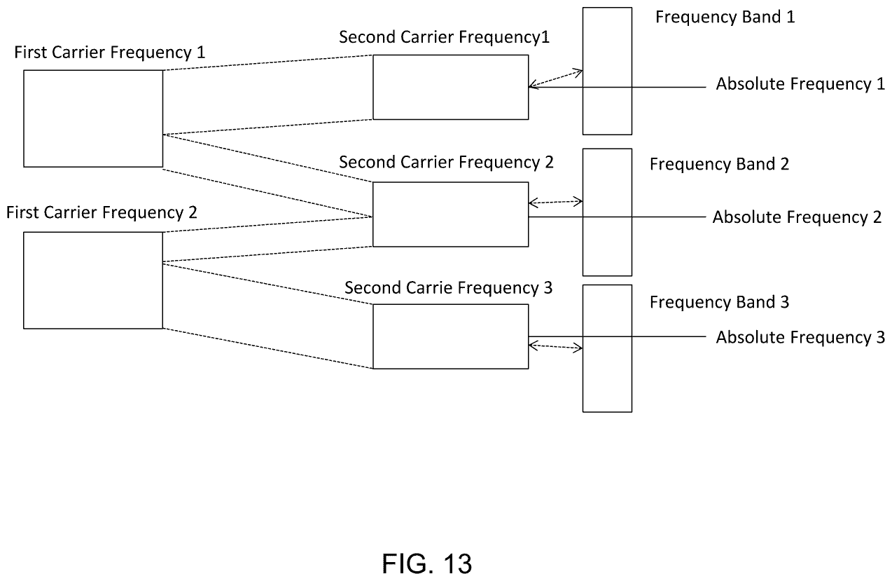

FIG. 13 is an example of mapping two first carrier frequencies to three second carrier frequencies.

The first part of the frequency range of the first carrier frequency 1 is mapped to the second carrier frequency 1, the second part of the frequency range of the first carrier frequency 1 is mapped to the second carrier frequency 2, and the first part of the frequency range of the first carrier frequency 2 is mapped to the second carrier frequency 2, and the second part of the frequency range of the first carrier frequency 2 is mapped to the second carrier frequency 3. The first carrier frequency 1 and the first carrier frequency 2 share the frequency range of the second carrier frequency 2. The bandwidth of the first carrier frequency 1 is equal to the sum of the bandwidth of the second carrier frequency 1 and the bandwidth of the part of the second carrier frequency 2 mapped by the first carrier frequency 1. The bandwidth of the first carrier frequency 2 is equal to the sum of the bandwidth of the second carrier frequency 3 and the bandwidth of he part of the second carrier frequency 2 mapped by the first carrier frequency 2.

### Embodiment 4

In this embodiment, the UE will report capability information, indicating whether the UE can support that one carrier corresponds to more than one carrier frequencies.

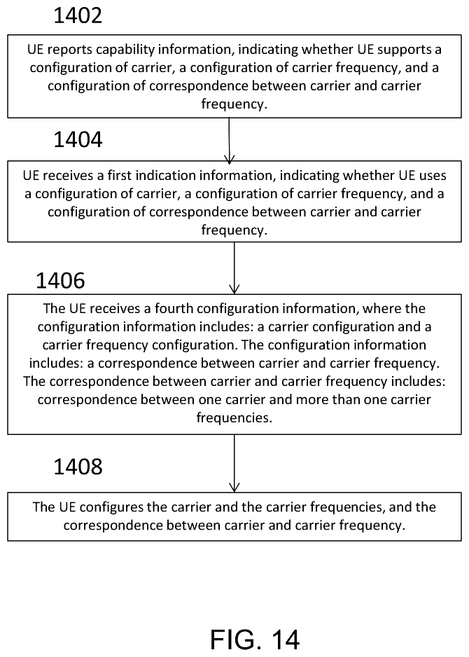

FIG. 14 is a flowchart of processing on the UE side of the method of the present invention in this embodiment, where the steps include:

Step 1 (1402): UE reports capability information, indicating whether UE supports a configuration of carrier, a configuration of carrier frequency, and a configuration of correspondence between carrier and carrier frequency. In general, UE reports the capability information to the network device. In the sidelink scenario, the Receive UE (RX UE) reports the capability information to the Transmit UE(TX UE).

Step 2 (1404): UE receives an indication information, indicating whether UE uses a configuration of carrier, a configuration of carrier frequency, and a configuration of correspondence between carrier and carrier frequency. If UE receives indication information, indicating UE cannot use the configuration there is no need to receive the configuration information for UE. UE will determine whether to receive the configuration information based on the received indication information. In general, the UE receives the indication information sent by the network device. In the sidelink scenario, the RX UE receives the indication information sent by the TX UE.

The indication information may include: a field with two options: true or false. If the field is configured as true, it indicates that the UE can use the configuration information; otherwise, the UE cannot use the configuration information.

The indication information may include: UE-level indication information: UE will use the same indication information for all configured cells; or cell group-level indication information: indication information is the same for all cells in a cell group, and the indication information between the cell groups is independent; or cell-level indication information: the indication information between cells is independent.

The system message received by the UE in the IDLE state or the INACTIVE state includes the indication information, and the RRCsetup and/or RRCReconfiguration received by the UE in the connected state includes the indication information. The indication information is modified through the received RRCReconfiguration. During the cell handover process, the ReconfigurationWithSync received by the UE includes the indication information.

Step 3 (1406): The UE receives a fourth configuration information. The configuration information includes: a carrier configuration and a carrier frequency configuration. The configuration information includes: a correspondence between carrier and carrier frequency. The correspondence may be in the carrier configuration information, in the carrier frequency configuration information, or separately indicated.

The correspondence between carrier and carrier frequency includes: correspondence between one carrier and more than one carrier frequencies, or correspondence between M5 carriers and N5 carrier frequencies, with 1≤M5≤N5.

For the case where one carrier corresponds to more than one carrier frequencies, the bandwidth of one carrier is equal to the sum of the bandwidths of more than one carrier frequencies: BW_{C}=ΣBW_{F,j} where BW_{C} represents the bandwidth of the carrier and BW_{F,j} represents the bandwidth of the j-th carrier frequency.

For the case where M5 carriers corresponding to N5 carrier frequencies with 1≤M5≤N5, the sum of the bandwidths of M5 carriers is equal to the sum of the bandwidths of N5 carrier frequencies: Σ_{M5} BW_{C,i}=Σ_{N5} BW_{F,j} where BW_{C,i} represents the bandwidth of the i-th carrier and BW_{F,j} represents the bandwidth of the j-th carrier frequency.

In some embodiments, the configuration of the carrier includes: carrier index, sub-carrier spacing, and bandwidth. The configuration of the carrier frequency includes: the carrier frequency index, the absolute center frequency point in ARFCN, the bandwidth, and the frequency band. The correspondence between carrier and carrier frequency includes one of the following methods: the carrier frequency index is included in the carrier configuration; or the configuration of the carrier includes the configuration of the carrier frequency; or the carrier frequency configuration includes the index of the carrier; or the carrier configuration includes an array corresponding to carrier frequency information, each element in the array corresponds to one carrier frequency information, and the carrier frequency information includes: absolute frequency point, bandwidth, and frequency band list; or one configuration information includes a carrier index and carrier frequency index.

The radio resource control information element (RRC IE) and the configuration method for the configuration of the carrier, the configuration of the carrier frequency, and the configuration of the correspondence between carrier and carrier frequency in this embodiment are the same as those in the first embodiment, Embodiment 1.

The correspondence between carrier and carrier frequency is configured through an RRC message. The RRC message includes RRCsetup, RRCReconfiguration, ReconfigurationWithSync, or system messages. The system message includes: SIB1.

Further, the system message received by the UE in the IDLE state or the INACTIVE state includes the correspondence, and the RRCsetup and/or RRCReconfiguration received by the UE in the connected state includes the correspondence. During the cell handover process, the ReconfigurationWithSync received by the UE includes the correspondence. The correspondence between carrier and carrier frequency is modified through high-layer signaling, and the high-layer signaling includes: RRCReconfiguration.

The configuration of the correspondence between carrier and carrier frequency includes: UE-level configuration: UE is configured with the same corresponding for all configured cells; or Cell Group level configuration: UE is configured with one corresponding for each Cell Group, for all cells in the Cell Group the corresponding is the same; and the corresponding can be independently configured between cell groups; or Cell-level configuration: UE is configured with one corresponding for each cell, and the corresponding can be independently configured between the cells.

Step 4 (1408): the UE configures the carrier and the carrier frequencies, and configures the correspondence between carrier and carrier frequency.

The correspondence between carrier and carrier frequency includes: one carrier corresponds to more than one carrier frequencies or M5 carriers correspond to N5 carrier frequencies, where 1≤M5≤N5.

For the case where one carrier corresponds to more than one carrier frequencies, the bandwidth of one carrier is equal to the sum of the bandwidths of the more than one carrier frequencies: BW_{C}=ΣBW_{F,j} where BW_{C} represents the bandwidth of the carrier and BW_{F,j} represents the bandwidth of the j-th carrier frequency.

For the case where M5 carriers correspond to N5 carrier frequencies, the sum of the bandwidths of the M5 carriers is equal to the sum of the bandwidths of the N5 carrier frequencies: Σ_{M5} BW_{C}, =Σ_{N5} BW_{F,j} where BW_{C,i} represents the bandwidth of the i-th carrier and BW_{F,j} represents the bandwidth of the j-th carrier frequency.

Furthermore, the carrier is mapped to more than one carrier frequencies. Then the carrier corresponds to more than one different frequency ranges. A part of collection of subcarriers of the carrier are mapped to the frequency range of one carrier frequency and another part of collection of subcarriers of the carrier are mapped to the frequency range of another carrier frequency. Each subcarrier of the carrier corresponds to an absolute frequency. The subcarriers of the carrier mapped to a carrier frequency corresponds to an absolute center frequency. The subcarriers of the carrier mapped to a carrier frequency corresponds to one or more frequency band indications.

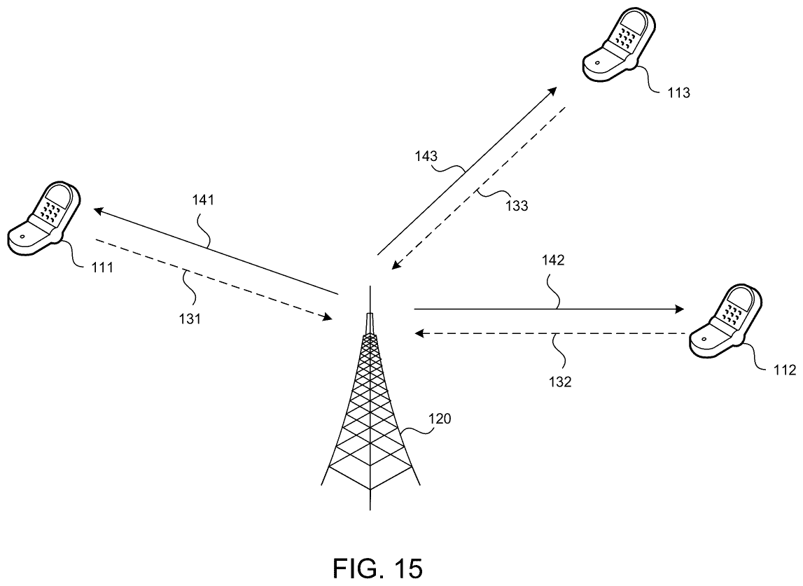

FIG. 15 shows an example of a wireless communication system (e.g., a long term evolution (LTE), 5G or NR cellular network, or next generation networks beyond 5G, such as 6th generation networks) that includes a base station (BS) 120 and one or more user equipment (UE) 111, 112 and 113. The base station, which is a network device, may be implemented on land (e.g., a cell tower) or in the air (e.g., a satellite or an aerial vehicle). In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

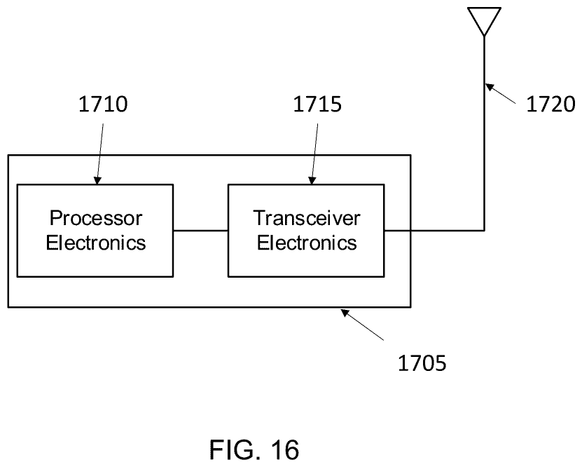

FIG. 16 is a block diagram representation of a portion of an apparatus, in accordance with some embodiments of the presently disclosed technology. An apparatus 1705 such as a network device or a base station or a wireless device (or UE), can include processor electronics 1710 such as a microprocessor that implements one or more of the techniques presented in this document. The apparatus 1705 can include transceiver electronics 1715 to send and/or receive wireless signals over one or more communication interfaces such as antenna(s) 1720. The apparatus 1705 can include other communication interfaces for transmitting and receiving data. Apparatus 1705 can include one or more memories (not explicitly shown) configured to store information such as data and/or instructions. In some implementations, the processor electronics 1710 can include at least a portion of the transceiver electronics 1715. In some embodiments, at least some of the disclosed techniques, modules or functions are implemented using the apparatus 1705.

Some embodiments may preferably implement the following solutions.

A first set of preferred solutions may include the following (e.g., as described with reference to Embodiment 1).

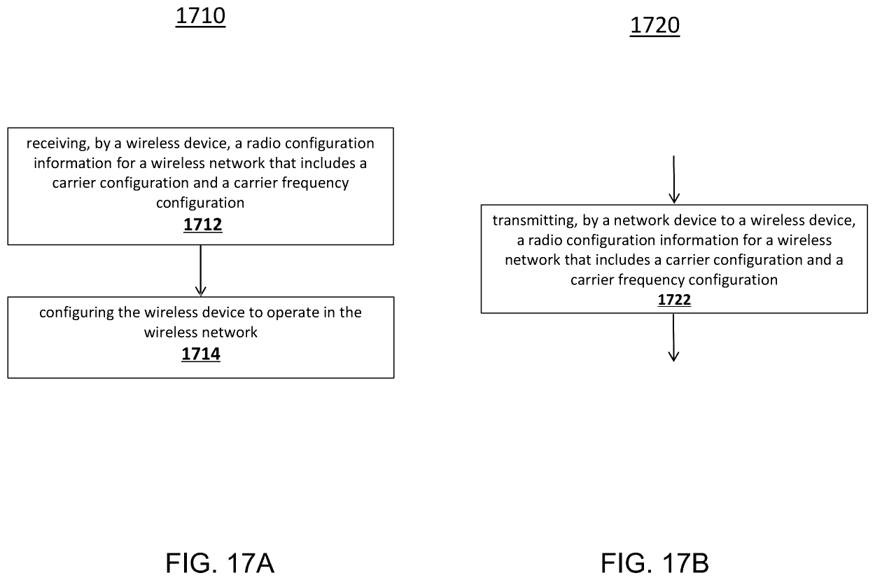

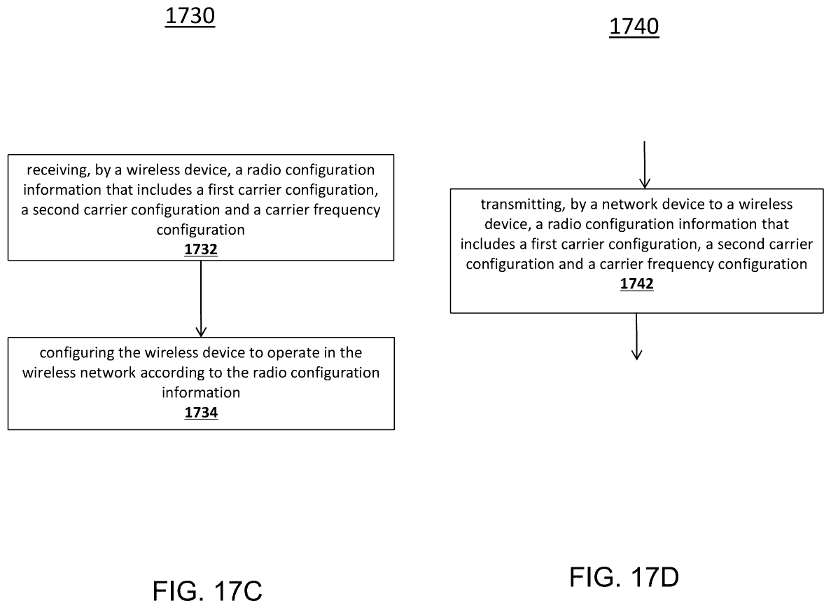

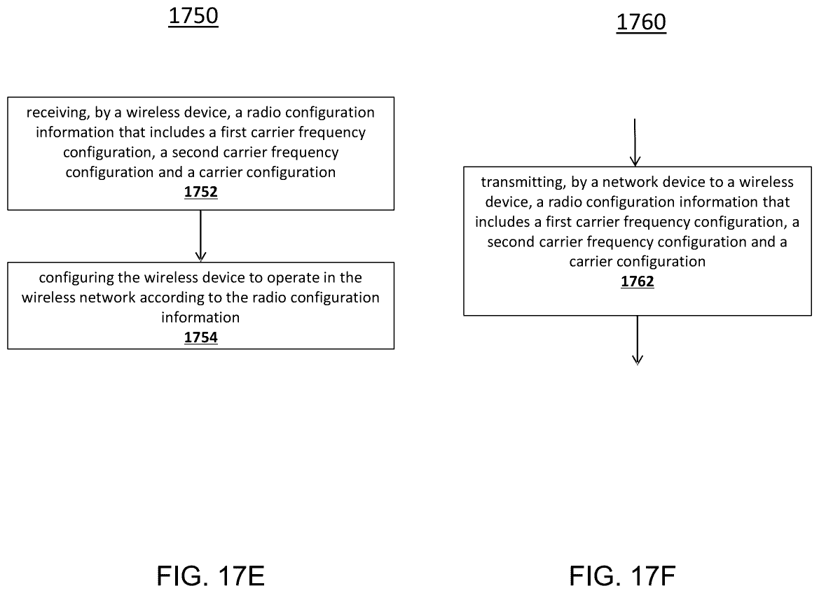

1. A method of wireless communication (e.g., method 1710 depicted in FIG. 17A), comprising: receiving (1712), by a wireless device, a radio configuration information for a wireless network that includes a carrier configuration and a carrier frequency configuration, wherein the radio configuration information indicates a correspondence between a carrier in the carrier configuration and more than one carrier frequencies in the carrier frequency configuration; and operating (1714) the wireless device according to the radio configuration information. For example, the wireless device may configure the carrier, and carrier frequencies, and the correspondence to operate in the wireless network according to the radio configuration information.

2. The method of solution 1, wherein a part of a collection of subcarriers of the carrier is mapped to a frequency range of one of the more than one carrier frequencies, and another part of the collection of subcarriers of the carrier is mapped to a frequency range of another one of the more than one carrier frequencies.

3. The method of solution 2, wherein frequency resources of the carrier include frequency resources of the more than one carrier frequencies.

4. The method of any of solutions 1-3, wherein a bandwidth of the carrier of operation is equal to a sum of bandwidths of the more than one carrier frequencies.

5. The method of any of solutions 1-4, wherein the correspondence is indicated in the carrier configuration.

6. The method of any of solutions 1-4, wherein the correspondence is indicated in the carrier frequency configuration.

7. The method of any of solutions 1-4, wherein the correspondence is indicated in a separate configuration in the radio configuration information.

8. A method of wireless communication (e.g., method 1720 depicted in FIG. 17B), comprising: transmitting (1722), by a network device to a wireless device, a radio configuration information for a wireless network that includes a carrier configuration and a carrier frequency configuration, wherein the radio configuration information indicates a correspondence between a carrier in the carrier configuration and more than one carrier frequencies in the carrier frequency configuration.

9. The method of solution 8, wherein a part of a collection of subcarriers of the carrier is mapped to a frequency range of one of the more than one carrier frequencies, and another part of the collection of subcarriers of the carrier is mapped to a frequency range of another one of the more than one carrier frequencies.

10. The method of solution 9, wherein frequency resources of the carrier include frequency resources of the more than one carrier frequencies.

11. The method of any of solutions 8-10, wherein a bandwidth of the carrier of operation is equal to a sum of bandwidths of the more than one carrier frequencies.

12. The method of any of solutions 8-11, wherein the correspondence is indicated in the carrier configuration.

13. The method of any of solutions 8-11, wherein the correspondence is indicated in the carrier frequency configuration.

14. The method of any of solutions 8-11, wherein the correspondence is indicated in a separate configuration in the radio configuration information.

A first set of preferred solutions may include the following (e.g., as described with reference to Embodiment 2).

1. A method of wireless communication (e.g., method 1730 depicted in FIG. 17C), comprising: receiving (1732), by a wireless device, a radio configuration information that includes a first carrier configuration, a second carrier configuration and a carrier frequency configuration, wherein the radio configuration information includes a first correspondence between a first carrier in the first carrier configuration and more than one second carriers in the second carrier configuration and a second correspondence between second carriers and one or more carrier frequencies; and operating (1734) the wireless device according to the radio configuration information. For example, the wireless device may configure the first carrier, the second carriers and the carrier frequencies and the first correspondence and the second correspondence to operate in the wireless network according to the radio configuration information.

2. The method of solution 1, wherein one part of a collection of subcarriers of the first carrier is mapped to a collection of subcarriers of one of the more than one second carriers, another part of the collection of subcarriers of the first carrier is mapped to a collection of subcarriers of another one of the more than one second carriers.

3. The method of solution 2, wherein frequency resources of the first carrier include frequency resources of the more than one second carriers.

4. The method of any of solutions 1-3, wherein a bandwidth of the first carrier is equal to a sum of bandwidths of the more than one second carriers.

5. The method of any of solutions 1-4, wherein the first correspondence or the second correspondence is indicated in the first carrier configuration or the second carrier configuration.

6. The method of any of solutions 1-4, wherein the first correspondence or the second correspondence is indicated in the carrier frequency configuration.

7. The method of any of solutions 1-4, wherein the first correspondence or the second correspondence is indicated in a separate configuration in the radio configuration information.

8. A method of wireless communication (e.g., method 1740 depicted in FIG. 17D), comprising: transmitting (1742), by a network device to a wireless device, a radio configuration information that includes a first carrier configuration, a second carrier configuration and a carrier frequency configuration, wherein the radio configuration information includes a first correspondence between a first carrier in the first carrier configuration and more than one second carriers in the second carrier configuration and a second correspondence between second carriers and one or more carrier frequencies.

9. The method of solution 8, wherein one part of a collection of subcarriers of the first carrier is mapped to a collection of subcarriers of one of the more than one second carriers, and another part of the collection of subcarriers of the first carrier is mapped to a collection of subcarriers of another one of the more than one second carriers.

10. The method of solution 9, wherein frequency resources of the first carrier include frequency resources of the more than one second carriers.

11. The method of any of solutions 8-10, wherein a bandwidth of the first carrier is equal to a sum of bandwidths of the more than one second carriers.

12. The method of any of solutions 8-11, wherein the first correspondence or the second correspondence is indicated in the first carrier configuration or the second carrier configuration.

13. The method of any of solutions 8-11, wherein the first correspondence or the second correspondence is indicated in the carrier frequency configuration.

14. The method of any of solutions 8-11, wherein the first correspondence or the second correspondence is indicated in a separate configuration in the radio configuration information.

A first set of preferred solutions may include the following (e.g., as described with reference to Embodiment 3).

1. A method of wireless communication (e.g., method 1750 depicted in FIG. 17E), comprising: receiving (1752), by a wireless device, a radio configuration information that includes a first carrier frequency configuration, a second carrier frequency configuration and a carrier configuration, wherein the radio configuration information includes a first correspondence between a first carrier frequency in the first carrier frequency configuration and more than one second carrier frequencies in the second carrier frequency configuration and a second correspondence between the first carrier frequencies and one or more carrier of operation; and operating (1754) the wireless device according to the radio configuration information. For example, the wireless device may configure the first carrier frequency, the second carrier frequencies, the carrier, the first correspondence, and the second correspondence to operate in the wireless network according to the radio configuration information.

2. The method of solution 1, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

3. The method of solution 2, wherein frequency resources of the first carrier frequency include frequency resources of the more than one second carrier frequencies.

4. The method of any of solutions 1-3, wherein a bandwidth of the first carrier frequency is equal to a sum of bandwidths of the more than one second carrier frequencies.

5. The method of any of solutions 1-4, wherein the first correspondence or the second correspondence is indicated in the first carrier frequency configuration or the second carrier frequency configuration.

6. The method of any of solutions 1-4, wherein the first correspondence or the second correspondence is indicated in the carrier configuration.

7. The method of any of solutions 1-4, wherein the first correspondence or the second correspondence is indicated in a separate configuration in the radio configuration information.

8. A method of wireless communication (e.g., method 1760 depicted in FIG. 17F), comprising: transmitting (1762), by a network device to a wireless device, a radio configuration information that includes a first carrier frequency configuration, a second carrier frequency configuration and a carrier configuration, wherein the radio configuration information includes a first correspondence between a first carrier frequency in the first carrier frequency configuration and more than one second carrier frequencies in the second carrier frequency configuration and a second correspondence between the first carrier frequencies and one or more carrier of operation.

9. The method of solution 8, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

10. The method of solution 9, wherein frequency resources of the first carrier frequency include frequency resources of the more than one second carrier frequencies.

11. The method of any of solutions 8-10, wherein a bandwidth of the first carrier frequency is equal to a sum of bandwidths of the more than one second carrier frequencies.

12. The method of any of solutions 8-11, wherein the first correspondence or the second correspondence is indicated in the first carrier frequency configuration or the second carrier frequency configuration.

13. The method of any of solutions 8-11, wherein the first correspondence or the second correspondence is indicated in the carrier configuration.

14. The method of any of solutions 8-11, wherein the first correspondence or the second correspondence is indicated in a separate configuration in the radio configuration information.

Some solutions may comprise an apparatus for wireless communication comprising a processor configured to implement the method of any of above listed solutions.

Some solutions may comprise a computer readable medium having code stored thereon. The code when executed by a processor, may cause the processor to implement a method recited in any of the above solutions.

It will be appreciated that the present disclosure provides a number of techniques that may be used in wireless networks. For example, more than one carrier frequencies (radio frequency carriers) correspond to one carrier (baseband carrier), may be performed such that

1) More than one carrier frequencies (radio frequency carriers) correspond to a carrier (baseband carrier), and the bandwidth of the carrier is equal to the sum of the bandwidth of these carrier frequencies.

2) More than one carrier frequencies (radio frequency carriers) correspond to more than one second carriers (a type of baseband carriers), and the more than one second carriers correspond to a first carrier (another type of baseband carriers), and the bandwidth of the first carrier is equal to the sum of the bandwidths of the more than one second carriers, and the sum of the bandwidths of the more than one second carriers is equal to the sum of the bandwidths of the more than one carrier frequencies.

3) More than one second carrier frequencies (a type of radio frequency carriers) correspond to a first carrier frequency (another type of radio frequency carriers), which corresponds to a carrier (baseband carrier), and the bandwidth of the first carrier frequency is equal to the sum of the bandwidths of the more than one second carrier frequencies and the bandwidth of the carrier is equal to the bandwidth of the first carrier frequency.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

1. A method of wireless communication, comprising:
receiving, by a wireless device, a radio configuration information that includes a first carrier frequency configuration, a second carrier frequency configuration and a carrier configuration,
wherein the radio configuration information includes a first correspondence between a first carrier frequency in the first carrier frequency configuration and more than one second carrier frequencies in the second carrier frequency configuration and a second correspondence between the first carrier frequency and one or more carrier of operation; and
operating the wireless device according to the radio configuration information.

2. The method of claim 1, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

3. The method of claim 2, wherein frequency resources of the first carrier frequency include frequency resources of the more than one second carrier frequencies.

4. The method of claim 1, wherein a bandwidth of the first carrier frequency is equal to a sum of bandwidths of the more than one second carrier frequencies.

5. The method of claim 1, wherein the first correspondence or the second correspondence is indicated in the first carrier frequency configuration or the second carrier frequency configuration.

6. The method of claim 1, wherein the first correspondence or the second correspondence is indicated in the carrier configuration.

7. The method of claim 1, wherein the first correspondence or the second correspondence is indicated in a separate configuration in the radio configuration information.

8. A method of wireless communication, comprising:
transmitting, by a network device to a wireless device, a radio configuration information that includes a first carrier frequency configuration, a second carrier frequency configuration and a carrier configuration,
wherein the radio configuration information includes a first correspondence between a first carrier frequency in the first carrier frequency configuration and more than one second carrier frequencies in the second carrier frequency configuration and a second correspondence between the first carrier frequency and one or more carrier of operation.

9. The method of claim 8, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

10. The method of claim 9, wherein frequency resources of the first carrier frequency include frequency resources of the more than one second carrier frequencies.

11. The method of claim 8, wherein a bandwidth of the first carrier frequency is equal to a sum of bandwidths of the more than one second carrier frequencies.

12. The method of claim 8, wherein the first correspondence or the second correspondence is indicated in the first carrier frequency configuration or the second carrier frequency configuration.

13. The method of claim 8, wherein the first correspondence or the second correspondence is indicated in the carrier configuration.

14. The method of claim 8, wherein the first correspondence or the second correspondence is indicated in a separate configuration in the radio configuration information.

15. An apparatus for wireless communication, comprising:
one or more processor configured to:
receive, by a wireless device, a radio configuration information that includes a first carrier frequency configuration, a second carrier frequency configuration and a carrier configuration,
wherein the radio configuration information includes a first correspondence between a first carrier frequency in the first carrier frequency configuration and more than one second carrier frequencies in the second carrier frequency configuration and a second correspondence between the first carrier frequency and one or more carrier of operation; and
operate the wireless device according to the radio configuration information.

16. The apparatus of claim 15, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

17. The apparatus of claim 16, wherein frequency resources of the first carrier frequency include frequency resources of the more than one second carrier frequencies.

18. An apparatus for wireless communication, comprising:
one or more processor configured to:
transmit, by a network device to a wireless device, a radio configuration information that includes a first carrier frequency configuration, a second carrier frequency configuration and a carrier configuration,
wherein the radio configuration information includes a first correspondence between a first carrier frequency in the first carrier frequency configuration and more than one second carrier frequencies in the second carrier frequency configuration and a second correspondence between the first carrier frequency and one or more carrier of operation.

19. The apparatus of claim 18, wherein a part of a frequency range of the first carrier frequency is mapped to a frequency range of one of the more than one second carrier frequencies, and another part of the frequency range of the first carrier frequency is mapped to a frequency range of another one of the more than one second carrier frequencies.

20. The apparatus of claim 19, wherein frequency resources of the first carrier frequency include frequency resources of the more than one second carrier frequencies.
